(19) United States
(12) Patent Application Publication
(10) Pub. No.: US 2019/0276590 A1
(43) Pub. Date: Sep. 12, 2019

(54) METHODS OF FORMING DYNAMIC CROSS-LINKED POLYMER COMPOSITIONS USING FUNCTIONAL CHAIN EXTENDERS UNDER CONTINUOUS PROCESS

(71) Applicant: SABIC GLOBAL TECHNOLOGIES B.V., BERGEN OP ZOOM (NL)

(72) Inventors: Husnu Alp Alidedeoglu, Evansville, IN (US); Manojkumar Chellamuthu, Evansville, IN (US); Ramon Groote, Oisterwijk (NL); Prashant Kumar, Evansville, IN (US)

(21) Appl. No.: 16/348,937

(22) PCT Filed: Nov. 15, 2017
(86) PCT No.: PCT/US2017/061686

§ 371 Date: May 10, 2019

Related U.S. Application Data
(60) Provisional application No. 62/422,461, filed on Nov. 15, 2016.

(51) Int. Cl. C08G 63/183; C08G 63/78

(52) U.S. Cl. CPC C08G 63/183; C08G 63/78

(57) ABSTRACT

Provided are methods for preparing dynamic cross-linked polymer compositions derived from 1,4-butane diol, a terephthalic acid and a chain extender combined via continuous polymerization.

### FIELD

The present disclosure relates to dynamic cross-linked polymer compositions, and in particular to dynamic cross-linked polymer compositions derived from an alcohol and a terephthalic acid combined via continuous polymerization.

### BACKGROUND

“Dynamic cross-linked polymer compositions” represent a versatile class of polymers. The compositions feature a system of covalently cross-linked polymer networks and can be characterized by the nature of their structure. At elevated temperatures, it is believed that the cross-links undergo transesterification reactions at such a rate that a flow-like behavior can be observed. Hence, the polymer can be processed much like a viscoelastic thermoplastic. At lower temperatures, these dynamic cross-linked polymer compositions behave more like classic thermosets. As the rate of inter-chain transesterification slows, the network becomes more rigid and static. The dynamic nature of their cross-links allows these polymers to be heated and reheated, and reformed, as the polymers resist degradation and maintain structural integrity at high temperatures.

Previously-described methods of making a dynamic cross-linked polymer composition by combining epoxides and carboxylic acids in the presence of a transesterification catalyst required feeding all components of the polymer into a vessel which was then heated to the processing temperature of the polymer. Once all the starting components were molten, the blend was mixed. During mixing, the cross-linking reaction would take place, which led to an increase in viscosity. While this method is suitable for some small-scale operations, it is cumbersome for larger scales due to difficulties in cleaning the reaction vessels and the stirring implements. In addition, this method does not readily allow for the production of pellets or other forms of material that can be re-worked, for example, by injection molding or profile extrusion.

Further, dynamically cross-linked polybutylene terephthalate (PBT) represent a growing class of dynamically cross-linked compositions. Conventional polybutylene terephthalate resins are semi-crystalline thermoplastics used in a variety of durable goods. PBT resins are now widely used for components in the electronics and automotive industries. Subsequently, the demand for PBT is projected to increase steadily over the coming years. Producers continue to face the challenge of meeting increasing demand for PBT while dealing with higher production costs. One approach to improving process yield and reducing cost on an industrial scale relates to using butylene terephthalate BT-oligomer to make PBT resins. BT-oligomer can be prepared from purified terephthalic acid and butanediol acid. To be useful in making PBT resin for specific end purposes, it is necessary to strictly control the carboxylic acid endgroup and intrinsic viscosity of the BT-oligomer.

There remains a need in the art for efficient methods of preparing dynamic cross-linked polymer compositions and a particular need for PBT dynamic cross-linked compositions.

### SUMMARY

The above-described and other deficiencies of the art are met by methods of preparing a dynamically cross-linked composition comprising: (a) contacting 1,4-butane diol (BDO) and purified terephthalic acid (PTA) so as to form a mixture, wherein a molar ratio of BDO to PTA is from 2:1 to 4:1; (b) in a continuous fashion, catalytically esterifying the mixture, catalytically transesterifying the mixture, or both, so as to give rise to a first product; (c) optionally supplying an additional amount of BDO to the first product; (d) subjecting a product of step (c) to a first stage at a first pressure and a first temperature and then a second stage at a second pressure and a second temperature, wherein the second pressure is less than the first pressure and wherein the second temperature is greater than the first temperature; (e) effecting, in a continuous fashion, an increase in intrinsic viscosity of a product of step (d), a decrease in carboxylic end group concentration of a product of step (d), or both; and (f) supplying in a continuous fashion a product of step (e), a chain extender, and optionally a metal compounded catalyst to at least one of a reactive extruder or a reactor and effecting a polycondensation reaction therein, wherein the product of step (e) and the chain extender and optional catalyst are subjected to a temperature of 230° C. to 255° C. and a pressure of 0.1 mbar to 16 mbar at a residence time of from 20 seconds to 6 hours.

Aspects of the disclosure further relate to a dynamically cross-linked network composition, comprising: a composition comprising a reaction product of polybutylene terephthalate and an amount of butanediol, the composition exhibiting a capability of relaxing internal residual stresses at a characteristic timescale of between about 0.1 and about 100,000 seconds above a glass transition temperature of the polybutylene terephthalate, as measured by stress relaxation rheology measurement.

The above described and other features are exemplified by the following drawings, detailed description, examples, and claims.

### BRIEF DESCRIPTION OF THE DRAWINGS

The following is a brief description of the drawings wherein like elements are numbered alike and which are exemplary of the various aspects described herein.

FIG. 1 depicts the storage (solid line) and loss (dashed line) modulus of the oscillatory time sweep measurement curves for a cross-linked polymer network.

FIG. 2 depicts the normalized modulus (G/G₀) for the dynamically cross-linked polymer network (solid line), as well as a line representing the absence of stress relaxation in a conventional cross-linked polymer network (dashed line, fictive data).

FIG. 3 presents Table 1 and example conditions for a slurry paste vessel and an esterification section of a tower reactor.

FIG. 4 presents Table 2 and example conditions of a cascade post-esterification portion tower reactor and the respective product properties.

FIG. 5 presents Table 3 and conditions of CSTRs and polycondensation reactor and product properties including intrinsic viscosity and carboxylic acid endgroup concentrations.

FIG. 6 depicts stress relaxation curves of PBT-DCN at 1.2 wt. % PMDA at 230° C. to 290° C.

FIG. 7 depicts an Arrhenius plot showing temperature dependence of characteristic relaxation time τ* for sample prepared with 1.2 wt. % PMDA.

FIG. 8 depicts stress relaxation curves of PBT-DCN with 1.2 wt. %, 2.5 wt. %, and 5 wt. % PMDA cross-linking agent at 250° C.

FIGS. 9A-9D depicts stress relaxation curves of PBT-DCN at varying amounts of PMDA cross-linking agent at varying temperatures.

### DETAILED DESCRIPTION OF ILLUSTRATIVE ASPECTS

The present disclosure may be understood more readily by reference to the following detailed description of desired aspects and the examples included therein. In the following specification and the claims that follow, reference will be made to a number of terms which have the following meanings.

Described herein are methods of making compositions, i.e., dynamic cross-linked polymer compositions. These compositions are advantageous because they can be prepared more readily than dynamic cross-linkable polymer compositions previously described in the art.

It is to be understood that the terminology used herein is for the purpose of describing particular aspects only and is not intended to be limiting. As used in the specification and in the claims, the term “comprising” can include the aspects “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

### Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise. As used in the specification and in the claims, the term “comprising” may include the aspects “consisting of” and “consisting essentially of” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the designated value, approximately the designated value, or about the same as the designated value. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Numerical values in the specification and claims of this application, particularly as they relate to polymers or polymer compositions, oligomers or oligomer compositions, reflect average values for a composition that may contain individual polymers or oligomers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

Ranges can be expressed herein as from one value (first value) to another value (second value). When such a range is expressed, the range includes in some aspects one or both of the first value and the second value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. As used herein, the terms “about” and “at or about” mean that the amount or value in question can be the designated value, approximately the designated value, or about the same as the designated value. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

As used herein, “Tm” refers to the melting point at which a polymer, or oligomer, completely loses its orderly arrangement. As used herein, “Tc” refers to the crystallization temperature at which a polymer gives off heat to break a crystalline arrangement.

The terms “Glass Transition Temperature” or “Tg” refer to the maximum temperature at which a polymer will still have one or more useful properties. These properties include impact resistance, stiffness, strength, and shape retention. The Tg therefore may be an indicator of its useful upper temperature limit, particularly in plastics applications. The Tg may be measured using a differential scanning calorimetry method and expressed in degrees Celsius.

As used herein, the terms “terephthalic acid group” and “isophthalic acid group” (“diacid groups”) “butanediol group,” “alcohol group,” “aldehyde group,” and “carboxylic acid group,” being used to indicate, for example, the weight percent of the group in a molecule, the term “isophthalic acid group(s)” means the group or residue of isophthalic acid having the formula (—(CO)C₆H₄(CO)—), the term “terephthalic acid group” means the group or residue of isophthalic acid having the formula (—(CO)C₆H₄(CO)—), the term “butanediol group” means the group or residue of butanediol having the formula (—(C₄H₈)—), the term “alcohol group” means the group or residue of hydroxide having the formula (—(OH)—), the term “aldehyde group” means the group or residue of an aldehyde having the formula (—(CHO)—), and the term “carboxylic acid group” means the group or residue of a carboxylic acid having the formula (—(COOH)—).

As used herein, “crosslink,” and its variants, refer to the formation of a stable covalent bond between two polymers. This term is intended to encompass the formation of covalent bonds that result in network formation, or the formation of covalent bonds that result in chain extension. The term “cross-linkable” refers to the ability of a polymer to form such stable covalent bonds.

As used herein, “dynamic cross-linked polymer composition” refers to a class of polymer systems that include dynamically, covalently cross-linked polymer networks. At low temperatures, dynamic cross-linked polymer compositions behave like classic thermosets, but at higher temperatures, for example, temperatures up to about 320° C., it is theorized that the cross-links have dynamic mobility, resulting in a flow-like behavior that enables the composition to be processed and re-processed. Dynamic cross-linked polymer compositions incorporate covalently crosslinked networks that are able to change their topology through thermo-activated bond exchange reactions. The network is capable of reorganizing itself without altering the number of cross-links between its atoms. At high temperatures, dynamic cross-linked polymer compositions achieve transesterification rates that permit mobility between crosslinks, so that the network behaves like a flexible rubber. At low temperatures, exchange reactions are very long and dynamic cross-linked polymer compositions behave like classical thermosets. The transition from the liquid to the solid is reversible and exhibits a glass transition. Put another way, dynamic cross-linked polymer compositions can be heated to temperatures such that they become liquid without suffering destruction or degradation of their structure. The viscosity of these materials varies slowly over a broad temperature range, with behavior that approaches the Arrhenius law. Because of the presence of the crosslinks, a dynamic cross-linked polymer composition will not lose integrity above the T_{g} or Tm like a thermoplastic resin will. The crosslinks are capable of rearranging themselves via bond exchange reactions between multiple crosslinks and/or chain segments as described, for example, by Kloxin and Bowman, Chem. Soc. Rev. 2013, 42, 7161-7173. The continuous rearrangement reactions may occur at room or elevated temperatures depending upon the dynamic covalent chemistry applicable to the system. The respective degree of cross-linking may depend on temperature and stoichiometry. Dynamic cross-linked polymer compositions of the invention can have T_{g} of about 40° C. to about 60° C. An article made from a dynamic cross-linked polymer composition can be heated and deformed, and upon returning to the original temperature, maintains the deformed shape. As such, articles in accordance with the present disclosure may comprise a shape generated by applying mechanical forces to a molded piece formed from the dynamic cross-linked polymer composition. This combination of properties permits the manufacture of shapes that are difficult or impossible to obtain by molding or for which making a mold would not be economical. Dynamic cross-linked polymer compositions generally have good mechanical strength at low temperatures, high chemical resistance, and low coefficient of thermal expansion, along with processability at high temperatures. Examples of dynamic cross-linked polymer compositions are described herein, as well as in U.S. Patent Application No. 2011/0319524, WO 2012/152859; WO 2014/086974; D. Montarnal et al., Science 334 (2011) 965-968; and J. P. Brutman et al, ACS Macro Lett. 2014, 3, 607-610. As an example, articles may be formed from the dynamic cross-linked polymer compositions of the present disclosure and may include composites, a thermoformed material, or a combination thereof. The articles may further comprise a solder bonded to the formed article.

Examining the nature of a given polymer composition can distinguish whether the composition is cross-linked, reversibly cross-linked, or non-crosslinked, and distinguish whether the composition is conventionally cross-linked or dynamically cross-linked. Dynamically cross-linked networks feature bond exchange reactions proceeding through an associative mechanism, while reversible cross-linked networks feature a dissociative mechanism. That is, the dynamically cross-linked composition remains cross-linked at all times, provided the chemical equilibrium allowing cross-linking is maintained. A reversibly cross-linked network however shows network dissociation upon heating, reversibly transforming to a low-viscous liquid and then reforming the cross-linked network upon cooling. Reversibly cross-linked compositions also tend to dissociate in solvents, particularly polar solvents, while dynamically cross-linked compositions tend to swell in solvents as do conventionally cross-linked compositions.

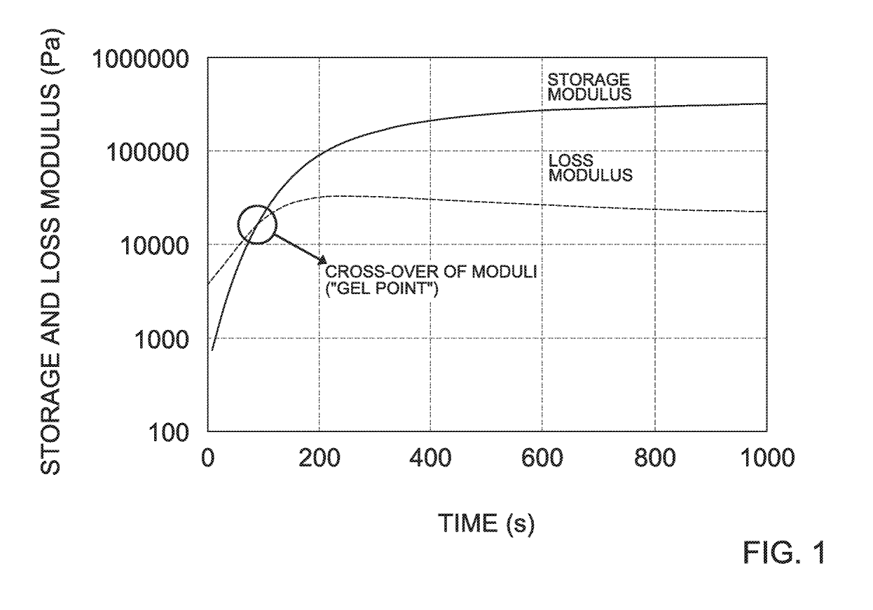

The cross-linked network apparent in dynamic and other conventional cross-linked systems may also be identified by rheological testing. An oscillatory time sweep (OTS) measurement at fixed strain and temperature may be used to confirm network formation. Exemplary OTS curves are presented in FIG. 1 for a cross-linked polymer network.

The orientation of the curves indicates whether or not the polymer has a cross-linked network. Initially, the loss modulus (viscous component) has a greater value than the storage modulus (elastic component) indicating that the material behaves like a viscous liquid. Polymer network formation is evidenced by the intersection of the loss and storage modulus curves. The intersection, referred to as the “gel point,” represents when the elastic component predominates the viscous component and the polymer begins to behave like an elastic solid.

In distinguishing between dynamic cross-linking and conventional (or non-reversible) cross-linking, a stress relaxation measurement may also, or alternatively, be performed at constant strain and temperature.

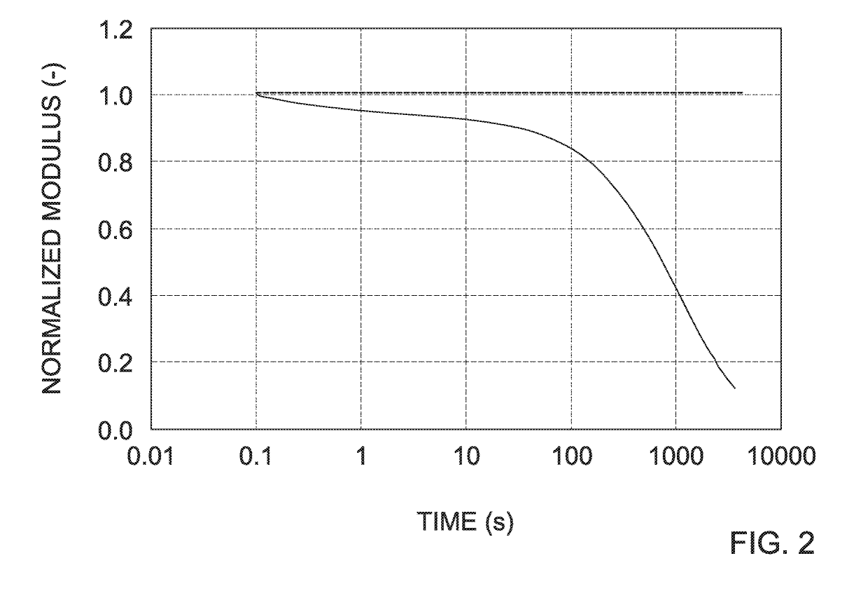

After network formation, the polymer may be heated and certain strain imposed on the polymer. The resulting evolution of the elastic modulus as a function of time reveals whether the polymer is dynamically or conventionally cross-linked. Exemplary curves for dynamically and conventionally cross-linked polymer networks are presented in FIG. 2.

Stress relaxation generally follows a multimodal behavior:

$$G / {G}_{0} = {\sum }_{i = 1}^{n} {C}_{i} exp ( - t / {τ}_{i} ) ,$$

where the number (n), relative contribution (Cᵢ) and characteristic timescales (τᵢ) of the different relaxation modes are governed by bond exchange chemistry, network topology and network density. For a conventional cross-linked networks, relaxation times approach infinity, τ→∞, and G/G₀=1 (horizontal dashed line). Apparent in the curves for the normalized modulus (G/G₀) as a function of time, a conventionally cross-linked network does not exhibit any stress relaxation because the permanent character of the cross-links prevents the polymer chain segments from moving with respect to one another. A dynamically cross-linked network, however, features bond exchange reactions allowing for individual movement of polymer chain segments thereby allowing for complete stress relaxation over time.

If the networks are DCNs, the networks may be able to relax any residual stress that is imposed on the material as a result of network rearrangement at higher temperature. The relaxation of residual stresses with time can be described with single-exponential decay function, having only one characteristic relaxation time τ*:

$$G ( t ) = G ( 0 ) \times exp ( - \frac{t}{{τ}^{*}} )$$

A characteristic relaxation time can be defined as the time needed to attain particular G(t)/G(0) at a given temperature. At lower temperature, stress relaxes slower, while at elevated temperature network rearrangement becomes more active and hence stress relaxes faster, proving the dynamic nature of the network. The influence of temperature on stress relaxation modulus clearly demonstrates the ability of cross-linked network to relieve stress or flow as a function of temperature. Additionally, the influence of temperature on the stress relaxation rate in correspondence with transesterification rate were investigated by fitting the characteristic relaxation time, τ* to an Arrhenius type equation.

ln τ*=−Eₐ/RT+ln A

where Eₐ is the activation energy for the transesterification reaction, A is the frequency factor, and R is the gas constant.

A composition, formed according to the present disclosure described herein, when subjected to a curing process may exhibit a plateau modulus of from about 0.01 megapascals (MPa) to about 1000 MPa, at a temperature above the melting temperature (and, depending on the composition, above the glass transition temperature) of the composition as measured by dynamic mechanical analysis. The cured pre-dynamic cross-linked polymer composition may further exhibit the capability of relaxing internal residual stresses at a characteristic timescale of between 0.1 and 100,000 seconds above the glass transition temperature of the polyester component, as measured by a stress relaxation rheology measurement. It should be understood that in the case of some polymers, (including some semi-crystalline polymers, e.g., polybutylene terephthalate (PBT)) the cured pre-dynamic cross-linked polymer composition may further exhibit the capability of relaxing internal residual stresses at a characteristic timescale of between 0.1 and 100,000 seconds above the Tm for that polymer.

Described herein are methods of preparing dynamic cross-linked polymer compositions via a continuous polymerization process. According to these methods, 1,4 butane diol (BDO) and a terephthalic acid may be contacted to form a mixture and the resultant mixture continuously catalytically esterified, catalytically transesterified, or both. Catalytic esterification or transesterification may proceed in a tower comprising a series of reactor zones, where, in the presence of an appropriate first catalyst, the mixture undergoes esterification or transesterification to form a first product. An additional amount of butanediol may be supplied to the first product to promote esterification or transesterification. The first product may have an intrinsic viscosity (IV) of 0.13 deciliters per gram (dl/g) to about 0.35 dl/g and a carboxylic acid endgroup concentration of between about 10 millimol per kilogram (mmol/kg) and about 180 mmol/kg.

In some aspects, the first product may be subjected to pressure and temperature adjustments after catalytic esterification or transesterification so as to provide a post-esterification product. The pressure and temperature adjustments may be effected as the first product proceeds through a series of cascade reactors. That is, the first product may be subjected to a first stage at a first pressure and a first temperature and then a second stage at a second pressure and a second temperature, wherein the second pressure is less than the first pressure and wherein the second temperature is greater than the first temperature. The temperature and pressure adjustments may effect a gradual increase (which increase may be a gradual one) in the intrinsic viscosity and a gradual decrease in the carboxylic endgroup concentration of the first product. The cascades may be disposed in or after a post-esterification module. The cascades may also be disposed in a pre-condensation module. Cascades may be effected during or after esterification or transesterification. Cascades may also be effected before or during condensation, and even after condensation.

The post-esterification product may be supplied in a continuous fashion with a chain extender and an optional metal catalyst to at least one of a reactive extruder or a reactor to undergo a polycondensation reaction therein. The first product, chain extender, and optional catalyst may be subjected to a temperature of 230° C. to 255° C. and a pressure of 0.1 millibar (mbar) to 16 mbar for a residence time of between 20 seconds and 6 hours to provide a final product The having an intrinsic viscosity between 0.55 dl/g and 1.35 dl/g and a carboxylic acid end group concentration of between about 0.1 and about 60 mmol/kg. In some aspects, the resultant mixture may undergo a curing process to form the dynamically cross-linked polymer composition.

In some aspects, the first product may be supplied to a reactor to undergo polycondensation, without undergoing post-esterification conditioning processes. A reactor feed including a chain extender, an appropriate catalyst, and the first product may be introduced to a reactor for polycondensation at a polycondensation temperature and a polycondensation pressure for a polycondensation residence time as described herein to provide the final product.

In various aspects, the 1,4 butanediol (BDO) and terephthalic acid may be combined to form a first mixture. The BDO and the terephthalic acid may be combined in a molar ratio of 2:1 to 4:1 or from about 2:1 to about 4:1. The ratio may be between 1.2:1 to 2.5:1 or from about 1.2:1 to about 2.5:1. More specifically, the molar ratio of the alcohol and terephthalic acid (for example, BDO and purified terephthalic acid, PTA) is 1.3:1 to 2.0:1, and specifically, 1.35:1 to 1.75:1. The mole ratio of BDO to purified terephthalic acid may refer to the mole ratio of the monomers, but may not account for BDO and PTA residues as oligomers or polymers.

Generally, the BDO and terephthalic acid may be combined at a temperature, pressure, and a residence time sufficient to allow a slurry or paste to form. As an example, the temperature may be maintained between 20° C. and 110° C. or about 20° C. to about 110° C., or 50° C. to 100° C. or from about 50° C. to about 100° C. In a particular example, the temperature may be maintained between 70° C. to 90° C. or between about 70° C. to about 90° C. The pressure may be maintained between 0.1 bar to 1.1 bar or about 0.1 bar and about 1.1 bar or between 0.8 bar to 1.05 bar or about 0.8 bar to about 1.05 bar. In a specific example, the pressure may be maintained between 0.9 bar and 1.02 bar or between about 0.9 bar and about 1.02 bar. The residence time to allow a slurry or paste to form may be between 1 hour and 4 hours or about 1 hour and about 4 hours, or between 2.5 hours and 3.5 hours or about 2.5 hours and 3.5 hours. In a preferred aspect, the alcohol and terephthalic acid may be combined for between about 1 and about 4 hours at a pressure of between about 0.8 bar to about 1.1 bar at a temperature of between about 20° C. to about 90° C.

The mixture may be catalytically esterified or catalytically transesterified, or both to give rise to a first product. Catalytic esterification or catalytic transesterification of the mixture may include reacting the mixture with a chain-extender in the presence of an appropriate esterification or transesterification catalyst.

In various aspects of the present disclosure, the catalytic esterification or transesterification of the mixture may proceed in at least a first reactor having a plurality of reactor zones, such as for example, a tower reactor. Tower reactors are known in the art and examples may be found, for example, in U.S. Pat. Nos. 7,259,227, 7,608,225, 8,110,149, and U.S. Pat. No. 8,252,888 to Schulz van Endert, et. al. Generally, the tower reactor may replace the first three reactors of a conventional polybutylene terephthalate polycondensation plant. Thus, the tower reactor may combine relevant reactor sections, or zones, within a single reactor. The tower reactor may have a plurality of reactor zones. The tower reactor may be configured so that at least some of the plurality of reactor zones comprise a cascade. The cascade reactor zones allow for a continuous circulation of reagents through the plurality of reactor zones of the tower reactor. In some aspects, the cascade may comprise four reactor zones. The tower reactor may also be configured such that a portion of the plurality of the reactor zones comprises a separator mechanism, such as a hydrocyclone. In some aspects, the tower reactor may be configured such that the plurality of reactor zones configured as a cascade are situated at an upper portion of the tower reactor, while the portion of the plurality of reactor zones comprising a hydrocyclone are situated at a lower portion, such as the lower third, of the tower reactor. In yet further aspects, the tower reactor may be configured such that the cascade and hydrocyclone reactor zones are in fluid communication with a central portion of the tower reactor, via, for example, a pipe.

In various aspects of the present disclosure, the tower reactor may comprise a plurality of reactor zones for at least one of an esterification or transesterification process. As such, the plurality of reactor zones may be equipped with reactor feed comprising a suitable catalyst to facilitate esterification or transesterification. An appropriate catalyst may be supplied to the plurality of reactors.

Each reactor of the plurality of reactors may be configured to operate at a particular pressure and temperature to receive the continuously fed mixture. In some aspects, the mixture may be subjected to esterification in the first reactor comprising a tower reactor having a plurality of reactor zones. The temperature in the plurality of reactor zones may be between 230° C. to 250° C., and the pressure in the range of 0.5 to 0.9 bar with a residence time in the plurality of reactor zones of 70 to 150 minutes. In a further example, the mixture may be subjected to esterification in the plurality of reactor zones of the first reactor at a temperature between 240° C. and 250° C., a pressure between 0.65 bar and 0.85 bar, and a residence time between 80 minutes and 120 minutes. In some aspects, the throughput of the esterification portion is about 7,000 to 10,000 kilograms/hour (kg/hr).

To effect catalytic esterification or transesterification, in addition to the mixture, the first reactor may be supplied with a first quantity of the first catalyst tetraisopropyl titanate (TPT) while water, tetrahydrofuran (THF), and BDO may be removed from the esterification section as overheads. For example, between 60 parts per million (ppm) and 120 ppm of catalyst may be supplied. In a further example, BDO and PTA may be present in a mole ratio of 1.6:1 to 3:1, specifically 1.8:1 to 2.8:1, more specifically 2:1 to 2.67:1. In yet further examples, BDO and PTA may be present in a mole ratio of 1.8:1 and 3.0:1. Additional BDO may be introduced to the tower reactor system to facilitate the esterification and/or transesterification processes. The first product may comprise an oligomer from the esterification/transesterification reaction. For example, the first product may comprise a butylene terephthalate oligomer.

In some aspects, the first product formed from the catalytic transesterification or catalytic transesterification may be continuously heated at a particular pressure and for a particular residence time in subsequent reactor zones before proceeding to a post esterification or post transesterification portion of the tower reactor. For example, the first product may be maintained at a temperature between 225° C. and 280° C. at a pressure between 1 and 10 bar for between about 2 minutes and 8 minutes. The first product may be subjected to post-esterification conditioning processes or the first product may proceed to a reactor for polycondensation to provide the final product, a dynamically crosslinked polymer composition.

For post-esterification processing, the first product may proceed to the post-esterification or post-transesterification portion of the tower reactor. The post-esterification portion of the tower reactor may comprise a cascade, or a series of cascade reactors portion of the tower reactor, for post-esterification conditioning to provide a post-esterification product. Post-esterification or post-transesterification processes may promote full oligomerization of the first product, such that any remaining monomer is consumed or converted to oligomer. As such, the post-esterification conditioning may increase the intrinsic viscosity of the oligomer. In some aspects, the post-esterification product may have an intrinsic viscosity between 0.08 dl/g and 0.2 dl/g and a carboxylic acid endgroup concentration between 10 mmol/kg and 300 mmol/kg.

In some aspects, post-esterification may proceed in the cascade portion of the plurality of reactor zones (tower reactor). In post-esterification (or post transesterification) conditioning, the first product may be subjected to a first stage at a first pressure and a first temperature and then a second stage at a second pressure and a second temperature, wherein the second pressure is less than the first pressure and wherein the second temperature is greater than the first temperature. The temperature and pressure adjustments may effect a gradual increase in the intrinsic viscosity and a gradual decrease in the carboxylic endgroup concentration of the first product in the cascade portion of the tower reactor to provide a post-esterification product.

In one example, the cascade reactor zones may comprise four cascade zones of the plurality of reactor zones. The reaction conditions (i.e., temperature, pressure, residence time) at each cascade zone may be altered and more specifically may be altered in succession with respect to the position of the particular cascade zone within the tower reactor. The pressure at each cascade may be subsequently reduced from 1 bar to 0.2 bar and the temperature of each cascade may be subsequently increased from 230° C. to 270° C. As used herein, pressure “subsequently reduced” from 1 bar to 0.15 bar signifies that the pressure may be reduced from one cascade zone to the subsequent cascade zone and so forth. Similarly, temperature “subsequently increased” from 230° C. to 270° C. signifies that the temperature may be increased from one cascade zone to the subsequent cascade zone and so forth. The residence time for each cascade zone may be between 2 minutes and 30 minutes, specifically between 5 and 25 minutes.

In a specific example, each cascade is maintained at a different temperature, 241° C., 242° C., 243° C., and 245° C. and a different pressure (0.3 bar to 0.22 bar). Each cascade also has a different residence time (14 minutes, 10 minutes, 10 minutes, and 15 minutes). The temperature increases from the top, or a first, cascade to the bottom, or final, cascade while the pressure decreases from the top to the bottom cascades. Each cascade may be supplied with a nitrogen feed to maintain an inert atmosphere. The intrinsic viscosity of the first product may increase from 0.08 dl/g to 0.15 dl/g in the post esterification cascade portion and the carboxylic acid concentration may decrease from 600 mmol/kg to 35 mmol/kg.

In various aspects, an additional quantity of the catalyst may be introduced to the cascade portion of the plurality of reactor zones in the tower reactor. As an example, a second quantity of catalyst, such as for example TPT, may be introduced to the cascade zones. More specifically, between about 25 ppm and 100 ppm may be introduced to the fourth cascade.

In an aspect, a product obtained from post-esterification in the cascade reactor zones, referred to as the post-esterification product, may have an intrinsic viscosity of between 0.1 dl/g and 0.2 dl/g and a carboxylic acid end group (CEG) concentration of between 10 and 1000 mmol/kg, or in some aspects, between 0.08 and 0.20 dl/g and a CEG concentration between 10 and 300 mmol/kg. The post-esterification process may have a conversion of between 95% and 99.5% based on free PTA. More particularly, the post-esterification product may have an intrinsic viscosity of between 0.12 dl/g and 0.18 dl/g and a carboxylic acid end group concentration of between 15 mmol/kg and 80 mmol/kg. A post-esterification process may have a conversion between 97% and 99.5%. In a yet further example, the post esterification product may have an intrinsic viscosity of between 0.1 dl/g and 0.2 dl/g and a carboxylic acid end group concentration of between 10 mmol/kg and 100 mmol/kg. The post-esterification process may have a conversion of between 95% and 99.5% based on free PTA.

The post-esterification process may have a throughput of about 7,000 kilograms per hour to about 10,000 kg/hr. Water, THF, byproducts, and BDO may be removed from the post-esterification section as overheads. The collected BDO may be purified and supplied to the reactors of the present disclosure.

The post-esterification product may proceed to a reactor for polycondensation reaction to provide the final product, a dynamically cross-linked polymer composition. In some aspects, prior to polycondensation an increase in the intrinsic viscosity and a decrease in carboxylic acid end group concentration of the product of the post-esterification process may be effected in a continuous fashion to provide a modified post-esterification product. The increase in the intrinsic viscosity and decrease in the carboxylic acid endgroup concentration may be achieved in one or more continuously stirred reactors maintained at particular temperature and pressure for a given residence time. One or more of the reactors may be at a temperature between 225° C. and 260° C. and at a pressure of between 0.1 mbar and 70 mbar, or between about 0.1 mbar and 70 mbar, for a residence time of between 10 minutes and 60 minutes or between about 10 minutes and about 60 minutes. The reactor may operate at a second temperature between 225° C. and 250° C., or between about 225° C. and 250° C., and a melt pressure of 5 mbar to 70 mbar or from about 5 mbar to about 70 mbar for a residence time of between 10 minutes and 60 minutes, or between about 10 minutes and 60 minutes. In some aspects, a given reactor may operate at a first set of conditions (e.g., pressure, temperature) and then operate at a second set of conditions. In some aspects, material may be transferred from a reactor operating at a first set of conditions to a reactor operating at a second set of conditions. In one example, the product may be continuously supplied to a second one of the reactors at a temperature of 235° C. to 245° C. (or between about 235° C. and about 245° C.) and a second pressure of 5 mbar to 60 mbar, preferably 5 mbar to 40 mbar, or more preferably 5 mbar to 30 mbar for a residence time between 30 minutes and 50 minutes or between about 30 minutes and about 50 minutes. A second of the continuously stirred reactors reactor may operate at a second temperature between 230° C. and 260° C. or between about 230° C. and about 260° C. and a pressure of between 0.1 mbar and 35 mbar or between about 0.1 mbar and about 35 mbar for a residence time of between 10 minutes and 60 minutes or between about 10 minutes and 60 minutes. For example, the modified post-esterification product may be continuously supplied to a reactor at a temperature of between 235° C. and 250° C. or between 235° C. and about 250° C. at a pressure of between 0.1 mbar and 16 mbar or between about 0.1 mbar to about 16 mbar for a residence time of between 20 minutes and 60 minutes or between about 20 minutes and about 60 minutes so that the modified post-esterification product has an intrinsic viscosity of between 0.2 dl/g and 0.4 dl/g, or between about 0.2 dl/g and about 0.4 dl/g, and a carboxylic acid end group concentration of 0.1 mmol/kg to 40 mmol/kg or of about 0.1 mmol/kg to about 40 mmol/kg.

The effecting an increase in intrinsic viscosity and decrease in carboxylic end group concentration of the post-esterification product may occur in a number of reactors. The reactors may comprise a number of vessels suitable for agitating and heating. In one example, the reactors may comprise continuously stirred tank reactors.

The post-esterification product or the modified post-esterification product (of which the intrinsic viscosity has been increased and the carboxylic acid endgroup concentration decreased) may be supplied to a reactor to undergo polycondensation. A reactor feed including a chain extender, an appropriate catalyst, and the post-esterification product or the modified post-esterification product may be introduced to a reactor for polycondensation at a polycondensation temperature and a polycondensation pressure for a polycondensation residence time.

In some aspects, the post-esterification product or the modified post-esterification product may be heated to enable a polycondensation reaction to occur, and heating is carried out at a temperature (a “polycondensation temperature”) and at a pressure (a “polycondensation pressure”) sufficient and for a time sufficient (“polycondensation residence time”) to provide a final product, a dynamically cross-linked composition. In some aspects, the polycondensation reaction occurs at temperatures of up to 260° C. or up to about 260° C. In yet other aspects, polycondensation occurs at temperatures of between 70° C. and 260° C. or between about 70° C. and about 260° C. In yet other aspects, polycondensation occurs at temperatures of between 190° C. and 260° C. or between about 190° C. and about 260° C. In other aspects, polycondensation occurs at temperatures of between 230° C. and 255° C. or between about 230° C. and about 255° C. Heating at a polycondensation temperature is suitably performed at a sufficient pressure to provide a dynamically cross-linked composition. In some aspects, the polycondensation may be between 0.1 mbar and 16 mbar or between about 0.1 mbar and about 16 mbar.

In yet further aspects of the present disclosure, the post-esterification product or the modified post-esterification product is heated at a polycondensation temperature and at a polycondensation pressure for a time sufficient to initiate polycondensation and to form the dynamic cross-linked polymer composition. The post-esterification product or the modified post-esterification product undergoes a polycondensation reaction for a sufficient residence time as the desired temperature and at the decreased pressure. In an aspect, the polycondensation residence time can be up to 6 hours. In other aspects, the polycondensation residence time occurs for up to 2 hours or up to about 2 hours. In further aspects, the polycondensation reaction of the second or fourth mixture occurs for between about 30 minutes and about 2 hours or between 30 minutes and 2 hours. In still other aspects, the polycondensation residence time occurs for between 20 seconds and 10 minutes or between about 20 seconds and about 10 minutes.

In some aspects, a process for producing a dynamically crosslinked network material comprises: contacting in a continuous manner an amount of terephthalic and an amount of BDO so as to form a mixture; effecting in a continuous manner at least one of esterification or transesterification on the mixture so as to give rise to a first oligomer product; and effecting in a continuous manner polycondensation of the first oligomer product, the polycondensation comprising effecting at least one step of simultaneous pressure reduction and temperature increase on the first oligomer product, so as to give rise to a final product. The final product may comprise a DCN composition. BDO may be removed (e.g., via reduced pressure, via changed temperature, or by other methods) at one or more points in the process. For example, BDO may be removed from the final DCN product at the end of the process. Alternatively, BDO may be removed during one or more intermediate stages of the process.

The process of polycondensation may comprise effecting from one to four separate stages of pressure reduction and temperature increase on the first oligomer product. In certain aspects, the polycondensation may proceed in a tower reactor as described herein.

The final product may have an intrinsic viscosity in the range of from 0.55 dl/g to 1.35 dl/g or from about 0.55 dl/g to about 1.35 dl/g and a carboxylic acid endgroup concentration of from 0.1 mmol/kg to 60 mmol/kg or from about 0.1 mmol/kg to about 60 mmol/kg. The final product may be subjected to curing process to achieve a dynamically cross-linked polymer composition.

Various reactors may be used to achieve the processes described herein. As an example, a continuously stirred or agitated melt tank or melt reactor may be used for heating BDO and terephthalic acid and a series of one or more reactors may be used for polycondensation. In further aspects, a continuously stirred melt reactor may be used. The components of an industrial processor are readily known to the skilled practitioner. For example, the melt tank can be selected from the group consisting of a melt tank reactor, a melt tank extruder with or without internal screw conveying, and a conveying melt tube. The reactor for polycondensation processing is ideally a reactor that can be operated at steady state and where the temperature and concentration are identical everywhere within the reactor as well as at the exit point. A commonly used reactor is a continuous stirred tank reactor (CSTR).

The methods described herein can be carried out under ambient atmospheric conditions, but it is preferred that the methods be carried out under an inert atmosphere, for example, a nitrogen atmosphere. Preferably, the methods are carried out under conditions that reduce the amount of moisture in the resulting dynamic cross-linked polymer compositions described herein. For example, preferred dynamic cross-linked polymer compositions described herein will have less 3.0 wt. % or less than about 3.0 wt. %, less than 2.5 wt. % or less than about 2.5 wt. %, less than 2.0 wt. % or less than about 2.0 wt. %, less than 1.5 wt. % or less than about 1.5 wt. %, or less than 1.0 wt. % or less than about 1.0 wt. % of water (i.e., moisture), based on the weight of the dynamic cross-linked polymer composition.

The compositions of the present disclosure provide dynamically crosslinked compositions exhibiting the characteristic stress-relaxation behavior associated with formation of a dynamic network. In certain aspects of the present disclosure, to achieve a fully cured, dynamic cross-linked composition, compositions prepared herein undergo a post-curing step. The post-curing step may include heating the obtained composition to elevated temperatures for a prolonged period. The composition may be heated to a temperature just below its melt or deformation temperature. Heating to just below the melt or deformation temperature activates the dynamically cross-linked network, thereby, curing the composition to a dynamic cross-linked polymer composition. As an example, a composition prepared with a bisphenol A diglycidyl ether (BADGE) and a cycloaliphatic epoxy (ERL) as the epoxy cross-linking agent may require a post-curing step to establish a dynamically cross-linked network in the final product.

A post-curing step may be used to activate the dynamic cross-linked network in certain compositions of the present disclosure. Certain chain extenders or cross-linking agents may benefit from a post-curing step to facilitate the formation of the dynamically cross-linked network. For example, a post-curing step may be used for a composition prepared with a less reactive chain extender or cross-linking agent. Less reactive chain extenders or cross-linking agents may include epoxy chain extenders that generate secondary alcohols in the presence of a suitable catalyst. In yet further aspects of the present disclosure, certain compositions exhibit dynamically cross-linked network formation after a shorter post-curing step. In yet further aspects, compositions attain a dynamically cross-linked network formation and need not undergo a post-curing step. That is, these compositions do not require additional heating to achieve the dynamically cross-linked network. In some aspects, compositions derived from more reactive chain extenders exhibit dynamically cross-linked network behavior without heating. More reactive chain extenders can include epoxy chain extenders that generate primary alcohols in the presence of a suitable catalyst.

The dynamic cross-linked polymer compositions can be formed into any shape known in the art. Such shapes can be convenient for transporting the dynamic cross-linked polymer compositions described herein. Alternatively, the shapes can be useful in the further processing of the dynamic cross-linked polymer compositions described herein into dynamic cross-linked polymer compositions and articles comprising them. For example, the dynamic cross-linked polymer compositions can be formed into pellets. In other aspects, the dynamic cross-linked polymer compositions can be formed into flakes. In still further aspects, the dynamic cross-linked polymer compositions can be formed into powders.

The dynamic cross-linked polymer compositions described herein can be use in conventional polymer forming processes such as, for example, injection molding, compression molding, profile extrusion, blow molding, etc. For example, the dynamic cross-linked polymer compositions prepared according to the described methods can be melted and then injected into an injection mold to form an injection-molded article. The injection-molded article can then be cured by heating to temperatures of up to about 320° C., followed by cooling to ambient temperature. As an example, articles may be formed from the dynamic cross-linked polymer compositions of the present disclosure and may include composites, a thermoformed material, or a combination thereof. The articles may further comprise a solder bonded to the formed article.

Alternatively, the dynamic cross-linked polymer compositions described herein can be melted, subjected to compression molding processes, and then cured. In other aspects, the dynamic cross-linked polymer compositions described herein can be melted, subjected to profile extrusion processes, and then cured. In some aspects, the dynamic cross-linked polymer compositions described herein can be melted, subjected to blow molding processes, and then cured. The individual components of the dynamic cross-linked polymer compositions are described in more detail herein.

### Alcohol

The methods presented herein include an alcohol such as 1,4-butanediol for the preparation of dynamically cross-linked compositions. In some aspects, the alcohol component can comprise a dihydric alcohol. Exemplary dihydric alcohols can include ethylene glycol, 1,2-propylene glycol, 1,3-propylene glycol, 1,2-butanediol, 2,3-butanediol, 1,4-butanediol, tetramethyl cyclobutanediol, isosorbide, cyclohexane dimethanol (including 1,2-, 1,3-, and 1,4-cyclohexane dimethanol), bio-derived diols, hexylene glycols, and a combination thereof. In another aspect, the dihydric alcohol is selected from 1,4-butanediol, 1,3-propanediol, ethylene glycol, and combinations thereof. In a particular example, the dihydric alcohol is 1,4-butanediol.

### Terephthalic Acid

The methods of the present disclosure recite the reaction of an alcohol and a terephthalic acid in the preparation of dynamically cross-linked polymer composition. Terephthalic acids represent a group of aromatic dicarboxylic acids suitable for reaction with the alcohols disclosed herein to provide a dynamically cross-linked polymer composition. Examples of the aromatic dicarboxylic acid group include isophthalic acid groups, terephthalic acid groups, naphthalic acid groups and a combination thereof. The aromatic dicarboxylic group may also be derived from corresponding di(C1 to C3) alkyl esters. In a particular example of the present disclosure, the aromatic dicarboxylic acid group is derived from terephthalic acid or di(C1-3) alkyl ester thereof. More specifically, the present disclosure includes a purified terephthalic acid.

Other diacid may be appropriate to react with an alcohol for the preparation of a dynamically cross-linked composition as disclosed herein. Exemplary diacids may include, but are not limited to, naphthalene dicarboxylic acid and aliphatic dicarboxylic acid.

### Chain Extender/Cross-Linking Agent Component

The compositions of the present disclosure include a chain extender or a cross-linking agent. The chain extender, or cross-linking agent, of the present disclosure can be a monomeric or a polymeric compound. In an aspect, the chain extender can be functional, that is, the chain extender may exhibit reactivity with one or more groups of a given chemical structure. As an example, the chain extenders described herein may be characterized by one of two reactivities with groups present within the ester oligomer component. The chain extender may react with (1) the carboxylic acid end group moiety or (2) the alcohol end group moiety of the ester oligomer component.

Useful monomeric chain extenders exhibiting reactivity with the carboxylic groups of the ester oligomer include epoxy based chain extenders. Various epoxy chain extenders or crosslinking agent and their feed amount may largely affect the networks' property by affecting the crosslinking density and transesterification dynamic. The epoxy moiety of the monomeric chain extender may directly react with the carboxylic acid endgroup of the ester oligomer in the presence of the transesterification catalyst. In an aspect, the epoxy-containing chain extender may be multi-functional, that is having at least two epoxy groups. The epoxy-chain extender generally has at least two epoxy groups, and can also include other functional groups as desired, for example, hydroxyl (—OH). Glycidyl epoxy resins are a particularly preferred epoxy-containing component.

Exemplary epoxy based chain extenders include a bisphenol A (BPA) epoxy shown in Formula A (bisphenol A diglycidyl ether, BADGE) and a cycloaliphatic epoxy (ERL) shown in Formula B. The cycloaliphatic epoxy (ERL) may comprise ERL™-4221 (3,4-epoxy cyclohexyl methyl-3,4-epoxy cyclohexyl carboxylate).

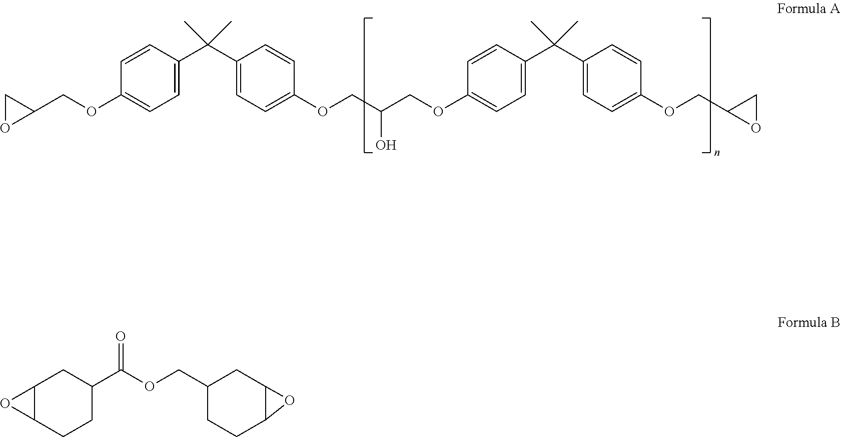

For a monomeric bisphenol A epoxy, the value of n is 0 in Formula (A). When n=0, this is a monomer. BADGE-based resins have excellent electrical properties, low shrinkage, good adhesion to numerous metals, good moisture resistance, good heat resistance and good resistance to mechanical impacts. In some aspects of the present disclosure, the BADGE has a molecular weight of about 1000 Daltons and an epoxy equivalent of about 530 grams per equivalent. As used herein, the epoxy equivalent is an expression of the epoxide content of a given compound. The epoxy equivalent is the number of epoxide equivalents in 1 g of resin (eq./g).

Preferred epoxy chain extenders of the present disclosure include monomeric epoxy compounds which generate a primary alcohol. In the presence of a suitable catalyst, the generated primary alcohol can readily undergo transesterification. As an example, and not to be limiting, exemplary epoxy chain extenders that generate a primary alcohol include certain cyclic epoxies. Exemplary cyclic epoxies that generate a primary alcohol in the presence of a suitable catalyst have a structure according to Formula C.

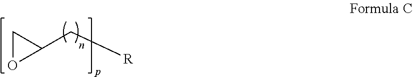

where n is greater than or equal to 1 and R can be any chemical group (including, but not limited to, ether, ester, phenyl, alkyl, alkynyl, etc.). In preferred aspects of the present disclosure, p is greater than or equal to 2 such that there are at least 2 of the epoxy structural groups present in the chain extender molecular. BADGE is an exemplary epoxy chain extender where R is bisphenol A, n is 1, and p is 2.

Other exemplary monomeric epoxy chain extenders include diglycidyl benzenedicarboxylate (Formula D) and triglycidyl benzene tricarboxylate (Formula E).

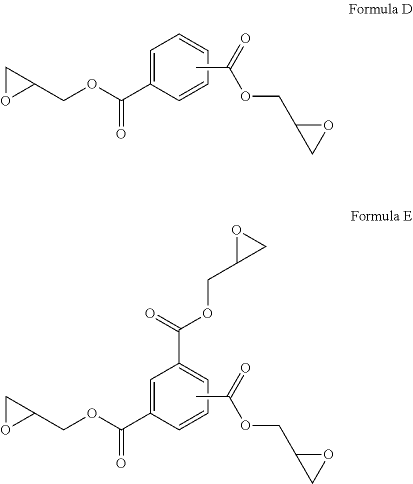

The epoxy-based monomeric chain extender may be present as a component as a percentage of the total weight of the composition. In some aspects, the epoxy-based monomeric chain extender may be present in an amount of from about 1 wt. % to about 10 wt. %, or from 1 wt. % to less than 5 wt. %. For example, the epoxy-based monomeric chain extender may be present in an amount of about 1, 2, 3, 4, 5, 6, 7, 8, 9, or about 10 wt. %. In one aspect, the epoxy-based monomeric chain extender may be present in an amount of about 2.5 wt. %.

As noted herein, the monomeric chain extender is a compound reactive with the alcohol moiety present in the ester oligomer component. Such chain extenders include a dianhydride compound. The dianhydride compound facilitates network formation by undergoing direct esterification with the ester oligomer. In the presence of a suitable catalyst, the dianhydride can undergo ring opening, thereby generating carboxylic acid groups. The generated carboxylic acid groups undergo direct esterification with the alcohol groups of the ester oligomer.

An exemplary class of monomeric chain extender that is reactive with the alcohol moiety present in the ester oligomer include dianhydrides. A preferred dianhydride is a pyromellitic dianhydride as provided in Formula F.

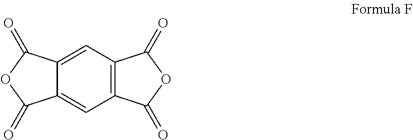 [SMILES: O=c1oc(=O)c2cc3c(=O)oc(=O)c3cc12]

Exemplary polymeric chain extenders exhibiting reactivity with the carboxylic groups of the ester oligomer include chain extenders having high epoxy functionality. High epoxy functionality can be characterized by the presence of between 200 and 300 equivalent per mole (eq/mol) of glycidyl epoxy groups.

An exemplary polymeric chain extenders is an epoxidized styrene-acrylic copolymer CESA. CESA is a copolymer of styrene, methyl methacrylate, and glycidyl methacrylate.

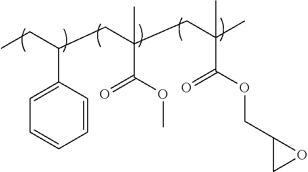

A preferred CESA according to the methods of the present disclosure has average molecular weight of about 6800 g/mol and an epoxy equivalent of 280 g/mol. As used herein, the epoxy equivalent is an expression of the epoxide content of a given compound. The epoxy equivalent is the number of epoxide equivalents in 1 kg of resin (eq./g).

The polymeric chain extender may be present as a component as a percentage of the total weight of the composition. In some aspects, the polymeric chain extender may be present in an amount of from about 1 wt. % to about 10 wt. %, or from 1 wt. % to less than 5 wt. %. For example, the polymeric chain extender may be present in an amount of about 1, 2, 3, 4, 5, 6, 7, 8, 9, or about 10 wt. %. In one aspect, the epoxy-containing polymeric chain extender may be present in an amount of about 2.5 wt. %.

### Catalysts

Certain catalysts may be used to catalyze the reactions described herein. One or more may be used herein to facilitate the formation of a network throughout the compositions disclosed. In one aspect, a catalyst may be used to facilitate the ring opening reaction of epoxy groups of the epoxy chain extender with the carboxylic acid end-group of the ester oligomer component. This reaction effectively results in chain extension and growth of the ester oligomer component via condensation, as well as to the in-situ formation of additional alcohol groups along the oligomeric backbone of the ester oligomer component. Furthermore, such a catalyst may subsequently facilitate the reaction of the generated alcohol groups with the ester groups of the ester oligomer component (a process called transesterification), leading to network formation. When such a catalyst remains active, and when free alcohol groups are available in the resulting network, the continuous process of transesterification reactions leads to a dynamic polymer network.

A catalyst may catalyze polycondensation by esterification of the alcohol and acid, and also the reaction between end-groups and chain-extender. A second catalyst may then catalyze transesterification to form cross-links. In some aspects, a single catalyst may catalyze all of the foregoing. As described herein, certain catalysts may be referenced as being a transesterification catalyst or a polycondensation catalyst. Although certain catalysts may be sufficient for use as both a transesterification and a polycondensation catalyst, for simplification, the following description details certain aspects of the transesterification catalyst and the polycondensation catalyst separately. It is understood that this separation and description is intended for example only and is not intended to be limiting regarding the use of various catalysts in various aspects of the processes described herein.

### Transesterification Catalyst

An example catalyst, as described herein, may be referred to as a transesterification catalyst. Generally, a transesterification catalyst facilitates the exchange of an alkoxy group of an ester by another alcohol. The transesterification catalyst as used herein facilitates reaction of free alcohol groups with ester groups in the backbone of the ester oligomer or its final dynamic polymer network. As mentioned before, these free alcohol groups are generated in-situ in a previous step by the ring-opening reaction of the epoxy chain extender with the carboxylic acid end-groups of the ester oligomer component. Certain transesterification catalysts are known in the art and are usually chosen from metal salts, for example, acetylacetonates, of zinc, tin, magnesium, cobalt, calcium, titanium, and zirconium. In certain aspects, the transesterification catalyst(s) is used in an amount up to about 25 wt. %, for example, about 0.001 wt. % to about 25 wt. %, of the total molar amount of ester groups in the ester oligomer component. In some aspects, the transesterification catalyst is used in an amount of from about 0.001 wt. % to about 10 wt. % or from about 0.001 wt. % to less than about 5 wt. %. Preferred aspects include about 0.001, about 0.05, about 0.1, and about 0.2 wt. % of catalyst, based on the number of ester groups in the ester oligomer component.

Suitable transesterification catalysts are also described in Otera, J. Chem. Rev. 1993, 93, 1449-1470. Tests for determining whether a catalyst will be appropriate for a given polymer system within the scope of the disclosure are described in, for example, U.S. Published Application No. 2011/0319524 and WO 2014/086974.

Tin compounds such as dibutyltinlaurate, tin octanote, dibutyltin oxide, dioxtyltin, dibutyldimethoxytin, tetraphenyltin, tetrabutyl-2,3-dichlorodistannoxane, and all other stannoxanes are envisioned as suitable catalysts. Rare earth salts of alkali metals and alkaline earth metals, particularly rare earth acetates, alkali metal and alkaline earth metals such as calcium acetate, zinc acetate, tin acetate, cobalt acetate, nickel acetate, lead acetate, lithium acetate, manganese acetate, sodium acetate, and cerium acetate are other catalysts that can be used. Salts of saturated or unsaturated fatty acids and metals, alkali metals, alkaline earth and rare earth metals, for example zinc stearate, are also envisioned as suitable catalysts. The catalyst may also be an organic compound, such as benzyldimethylamide or benzyltrimethylammonium chloride. These catalysts are generally in solid form, and advantageously in the form of a finely divided powder. A preferred catalyst is zinc(II)acetylacetonate.

### Polycondensation Catalyst

In some aspects, the compositions of the present disclosure are prepared using a polycondensation catalyst. The polycondensation catalyst may increase the polymer chain length (and molecular weight) by facilitating the condensation reaction between alcohol and carboxylic acid end-groups of the ester oligomer component in an esterification reaction. Alternatively, this catalyst may facilitate the ring opening reaction of the epoxy groups in the epoxy chain extender with the carboxylic acid end-groups of the ester oligomer component. The polycondensation catalyst is used in an amount of between 10 ppm and 100 ppm with respect to the ester groups in the ester oligomer component. In some aspects, the polycondensation catalyst is used in an amount of from 10 ppm to 100 ppm or from 10 ppm to less than 75 ppm. Preferred aspects include 20 ppm, 30 ppm, 50 ppm of catalyst, based on the oligomer component of the present disclosure. In a preferred aspect, the polycondensation catalyst is used in an amount of 50 ppm or about 50 ppm or 0.005 wt. % or about 0.005 wt. %.

Various titanium (Ti) based compounds have been proposed as polycondensation catalysts, because they are relatively inexpensive and safe. Described titanium-based catalysts include tetra-n-propyl titanate, tetraisopropyl titanate, tetra-n-butyl titanate, tetraphenyl titanate, tetracyclohexyl titanate, tetrabenzyl titanate, tetra-n-butyl titanate tetramer, titanium acetate, titanium glycolates, titanium oxalates, sodium or potassium titanates, titanium halides, titanate hexafluorides of potassium, manganese and ammonium, titanium acetylacetate, titanium alkoxides, titanate phosphites etc. The use of titanium based polycondensation catalysts in the production of polyesters has been described in EP0699700, U.S. Pat. No. 3,962,189, JP52062398, U.S. Pat. Nos. 6,372,879, and 6,143,837, for example. An exemplary titanium based polycondensation catalyst of the present disclosure is titanium(IV) isopropoxide, also known as tetraisopropyl titanate.

Other transesterification or polycondensation catalysts that can be used include metal oxides such as zinc oxide, antimony oxide, and indium oxide; metal alkoxides such as titanium tetrabutoxide, titanium propoxide, titanium isopropoxide, titanium ethoxide, zirconium alkoxides, niobium alkoxides, tantalum alkoxides; alkali metals; alkaline earth metals, rare earth alcoholates and metal hydroxides, for example sodium alcoholate, sodium methoxide, potassium alkoxide, and lithium alkoxide; sulfonic acids such as sulfuric acid, methane sulfonic acid, paratoluene sulfonic acid; phosphines such as triphenylphosphine, dimethylphenylphosphine, methyldiphenylphosphine, triterbutylphosphine; and phosphazenes.

### Additives

One or more additives may be combined with the components of the dynamic or pre-dynamic cross-linked polymer to impart certain properties to the polymer composition. Exemplary additives include: one or more polymers, ultraviolet agents, ultraviolet stabilizers, heat stabilizers, antistatic agents, anti-microbial agents, anti-drip agents, radiation stabilizers, pigments, dyes, fibers, fillers, plasticizers, fibers, flame retardants, antioxidants, lubricants, impact modifiers, wood, glass, and metals, and combinations thereof.

The compositions described herein may comprise an ultraviolet UV stabilizer for dispersing UV radiation energy. The UV stabilizer does not substantially hinder or prevent cross-linking of the various components of the compositions described herein. UV stabilizers may be hydroxybenzophenones; hydroxyphenyl benzotriazoles; cyanoacrylates; oxanilides; or hydroxyphenyl triazines. The compositions described herein may comprise heat stabilizers. Exemplary heat stabilizer additives include, for example, organophosphites such as triphenyl phosphite, tris-(2,6-dimethylphenyl)phosphite, tris-(mixed mono- and di-nonylphenyl)phosphite or the like; phosphonates such as dimethylbenzene phosphonate or the like; phosphates such as trimethyl phosphate, or the like; or combinations thereof.

The compositions described herein may comprise an antistatic agent. Examples of monomeric antistatic agents may include glycerol monostearate, glycerol distearate, glycerol tristearate, ethoxylated amines, primary, secondary and tertiary amines, ethoxylated alcohols, alkyl sulfates, alkylarylsulfates, alkylphosphates, alkylaminesulfates, alkyl sulfonate salts such as sodium stearyl sulfonate, sodium dodecylbenzenesulfonate or the like, quaternary ammonium salts, quaternary ammonium resins, imidazoline derivatives, sorbitan esters, ethanolamides, betaines, or the like, or combinations comprising at least one of the foregoing monomeric antistatic agents.

Exemplary polymeric antistatic agents may include certain polyesteramides polyether-polyamide (polyetheramide) block copolymers, polyetheresteramide block copolymers, polyetheresters, or polyurethanes, each containing polyalkylene glycol moieties polyalkylene oxide units such as polyethylene glycol, polypropylene glycol, polytetramethylene glycol, and the like. Such polymeric antistatic agents are commercially available, for example Pelestat™ 6321 (Sanyo) or Pebax™ MH1657 (Atofina), Irgastat™ P18 and P22 (Ciba-Geigy). Other polymeric materials may be used as antistatic agents are inherently conducting polymers such as polyaniline (commercially available as Panipol™ EB from Panipol), polypyrrole and polythiophene (commercially available from Bayer), which retain some of their intrinsic conductivity after melt processing at elevated temperatures. Carbon fibers, carbon nanofibers, carbon nanotubes, carbon black, or a combination comprising at least one of the foregoing may be included to render the compositions described herein electrostatically dissipative.

The compositions described herein may comprise anti-drip agents. The anti-drip agent may be a fibril forming or non-fibril forming fluoropolymer such as polytetrafluoroethylene (PTFE). The anti-drip agent can be encapsulated by a rigid copolymer as described above, for example styrene-acrylonitrile copolymer (SAN). PTFE encapsulated in SAN is known as TSAN. Encapsulated fluoropolymers can be made by polymerizing the encapsulating polymer in the presence of the fluoropolymer, for example an aqueous dispersion. TSAN can provide significant advantages over PTFE, in that TSAN can be more readily dispersed in the composition. An exemplary TSAN can comprise 50 wt % PTFE and 50 wt % SAN, based on the total weight of the encapsulated fluoropolymer. The SAN can comprise, for example, 75 wt % styrene and 25 wt % acrylonitrile based on the total weight of the copolymer. Alternatively, the fluoropolymer can be pre-blended in some manner with a second polymer, such as for, example, an aromatic polycarbonate or SAN to form an agglomerated material for use as an anti-drip agent. Either method can be used to produce an encapsulated fluoropolymer.

The compositions described herein may comprise a radiation stabilizer, such as a gamma-radiation stabilizer. Exemplary gamma-radiation stabilizers include alkylene polyols such as ethylene glycol, propylene glycol, 1,3-propanediol, 1,2-butanediol, 1,4-butanediol, meso-2,3-butanediol, 1,2-pentanediol, 2,3-pentanediol, 1,4-pentanediol, 1,4-hexandiol, and the like; cycloalkylene polyols such as 1,2-cyclopentanediol, 1,2-cyclohexanediol, and the like; branched alkylenepolyols such as 2,3-dimethyl-2,3-butanediol (pinacol), and the like, as well as alkoxy-substituted cyclic or acyclic alkanes. Unsaturated alkenols are also useful, examples of which include 4-methyl-4-penten-2-ol, 3-methyl-pentene-3-ol, 2-methyl-4-penten-2-ol, 2,4-dimethyl-4-penten-2-ol, and 9 to decen-1-ol, as well as tertiary alcohols that have at least one hydroxy substituted tertiary carbon, for example 2-methyl-2,4-pentanediol (hexylene glycol), 2-phenyl-2-butanol, 3-hydroxy-3-methyl-2-butanone, 2-phenyl-2-butanol, and the like, and cyclic tertiary alcohols such as 1-hydroxy-1-methyl-cyclohexane. Certain hydroxymethyl aromatic compounds that have hydroxy substitution on a saturated carbon attached to an unsaturated carbon in an aromatic ring can also be used. The hydroxy-substituted saturated carbon can be a methylol group (—CH₂OH) or it can be a member of a more complex hydrocarbon group such as —CR²⁴HOH or —CR²⁴₂OH wherein R²⁴ is a complex or a simple hydrocarbon. Specific hydroxy methyl aromatic compounds include benzhydrol, 1,3-benzenedimethanol, benzyl alcohol, 4-benzyloxy benzyl alcohol and benzyl alcohol. 2-Methyl-2,4-pentanediol, polyethylene glycol, and polypropylene glycol are often used for gamma-radiation stabilization.

The term “pigments” means colored particles that are insoluble in the resulting compositions described herein. Exemplary pigments include titanium oxide, carbon black, carbon nanotubes, metal particles, silica, metal oxides, metal sulfides or any other mineral pigment; phthalocyanines, anthraquinones, quinacridones, dioxazines, azo pigments or any other organic pigment, natural pigments (madder, indigo, crimson, cochineal, etc.) and mixtures of pigments. The pigments may represent from 0.05% to 15% by weight relative to the weight of the overall composition. Pigments, dyes or fibers capable of absorbing radiation may be used to ensure the heating of an article based on the compositions described herein when heated using a radiation source such as a laser, or by the Joule effect, by induction or by microwaves. Such heating may allow the use of a process for manufacturing, transforming or recycling an article made of the compositions described herein. The term “dye” refers to molecules that are soluble in the compositions described herein and that have the capacity of absorbing part of the visible radiation.

Exemplary fibers include glass fibers, carbon fibers, polyester fibers, polyamide fibers, aramid fibers, cellulose and nanocellulose fibers or plant fibers (linseed, hemp, sisal, bamboo, etc.) may also be envisaged.

Suitable fillers for the compositions described herein include: silica, clays, calcium carbonate, carbon black, kaolin, and whiskers. Other possible fillers include, for example, silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dihydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (atmospheres), or the like; kaolin, including hard kaolin, soft kaolin, calcined kaolin, kaolin comprising various coatings known in the art to facilitate compatibility with the polymeric matrix, or the like; single crystal fibers or “whiskers” such as silicon carbide, alumina, boron carbide, iron, nickel, copper, or the like; fibers (including continuous and chopped fibers) such as asbestos, carbon fibers, glass fibers (such as glass types E, A, C, ECR, R, S, D, or NE, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper and nickel or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, sisal, jute, starch, cork flour, lignin, ground nut shells, corn, rice grain husks or the like; organic fillers such as polytetrafluoroethylene; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as additional fillers and reinforcing agents such as mica, clay, feldspar, flue dust, fillite, quartz, quartzite, perlite, tripoli, diatomaceous earth, carbon black, or the like, or combinations comprising at least one of the foregoing fillers or reinforcing agents.

Plasticizers, lubricants, and mold release agents can be included. Mold release agent (MRA) will allow the material to be removed quickly and effectively. Mold releases can reduce cycle times, defects, and browning of finished product. There is considerable overlap among these types of materials, which may include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl) phosphate of hydroquinone and the bis(diphenyl) phosphate of bisphenol-A; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate (PETS), and the like; combinations of methyl stearate and hydrophilic and hydrophobic nonionic surfactants comprising polyethylene glycol polymers, polypropylene glycol polymers, poly(ethylene glycol-co-propylene glycol) copolymers, or a combination comprising at least one of the foregoing glycol polymers, e.g., methyl stearate and polyethylene-polypropylene glycol copolymer in a suitable solvent; waxes such as beeswax, montan wax, paraffin wax, or the like.

Various types of flame retardants can be utilized as additives. In one aspect, the flame retardant additives include, for example, flame retardant salts such as alkali metal salts of perfluorinated C₁-C₁₆ alkyl sulfonates such as potassium perfluorobutane sulfonate (Rimar salt), potassium perfluoroctane sulfonate, tetraethylammonium perfluorohexane sulfonate, potassium diphenylsulfone sulfonate (KSS), and the like, sodium benzene sulfonate, sodium toluene sulfonate (NATS) and the like; and salts formed by reacting for example an alkali metal or alkaline earth metal (for example lithium, sodium, potassium, magnesium, calcium and barium salts) and an inorganic acid complex salt, for example, an oxo-anion, such as alkali metal and alkaline-earth metal salts of carbonic acid, such as sodium carbonate Na₂CO₃, potassium carbonate K₂CO₃, magnesium carbonate MgCO₃, calcium carbonate CaCO₃, and barium carbonate BaCO₃ or fluoro-anion complex such as lithium hexafluoroaluminate Li₃AlF₆, barium hexafluorosilicate BaSiF₆, potassium tetrafluoroborate KBF₄, potassium hexafluoraluminate K₃AlF₆, potassium aluminum fluoride KAlF₄, potassium hexafluorosilicate K₂SiF₆, and/or sodium hexafluoroaluminate Na₃AlF₆ or the like. Rimar salt and KSS and NATS, alone or in combination with other flame retardants, are particularly useful in the compositions disclosed herein. In certain aspects, the flame retardant does not contain bromine or chlorine.

The flame retardant additives may include organic compounds that include phosphorus, bromine, and/or chlorine. In certain aspects, the flame retardant is not a bromine or chlorine containing composition. Non-brominated and non-chlorinated phosphorus-containing flame retardants can include, for example, organic phosphates and organic compounds containing phosphorus-nitrogen bonds. Exemplary di- or polyfunctional aromatic phosphorus-containing compounds include resorcinol tetraphenyl diphosphate (RDP), the bis(diphenyl) phosphate of hydroquinone and the bis(diphenyl) phosphate of bisphenol-A, respectively, their oligomeric and polymeric counterparts, and the like. Other exemplary phosphorus-containing flame retardant additives include phosphonitrilic chloride, phosphorus ester amides, phosphoric acid amides, phosphonic acid amides, phosphinic acid amides, tris(aziridinyl) phosphine oxide, polyorganophosphazenes, and polyorganophosphonates.

The flame retardant optionally is a non-halogen based metal salt, e.g., of a monomeric or polymeric aromatic sulfonate or mixture thereof. The metal salt is, for example, an alkali metal or alkali earth metal salt or mixed metal salt. The metals of these groups include sodium, lithium, potassium, rubidium, cesium, beryllium, magnesium, calcium, strontium, francium and barium. Examples of flame retardants include cesium benzenesulfonate and cesium p-toluenesulfonate. See e.g., U.S. Pat. No. 3,933,734, EP 2103654, and US2010/0069543A1, the disclosures of which are incorporated herein by reference in their entirety.

Another useful class of flame retardant is the class of cyclic siloxanes having the general formula [(R)₂SiO]_{y} wherein R is a monovalent hydrocarbon or fluorinated hydrocarbon having from 1 to 18 carbon atoms and y is a number from 3 to 12. Examples of fluorinated hydrocarbon include, but are not limited to, 3-fluoropropyl, 3,3,3-trifluoropropyl, 5,5,5,4,4,3,3-heptafluoropentyl, fluorophenyl, difluorophenyl and trifluorotolyl. Examples of suitable cyclic siloxanes include, but are not limited to, octamethylcyclotetrasiloxane, 1,2,3,4-tetramethyl-1,2,3,4-tetravinylcyclotetrasiloxane, 1,2,3,4-tetramethyl-1,2,3,4-tetraphenylcyclotetrasiloxane, octaethylcyclotetrasiloxane, octapropylcyclotetrasiloxane, octabutylcyclotetrasiloxane, decamethylcyclopentasiloxane, dodecamethylcyclohexasiloxane, tetradecamethylcycloheptasiloxane, hexadecamethylcyclooctasiloxane, eicosamethylcyclodecasiloxane, octaphenylcyclotetrasiloxane, and the like. A particularly useful cyclic siloxane is octaphenylcyclotetrasiloxane.

Exemplary antioxidant additives include organophosphites such as tris(nonyl phenyl)phosphite, tris(2,4-di-t-butylphenyl)phosphite (“Irgafos™ 168” or “I-168”), bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)] methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants.

### Articles and Processes

Articles can be formed from the compositions described herein. Generally, the ester oligomer component, the monomeric chain extender, and the transesterification and polycondensation catalysts are combined and heated to provide a molten mixture which is reacted under decreased pressure to form the dynamic cross-linked compositions described herein. The compositions described herein can then form, shaped, molded, or extruded into a desired shape. The term “article” refers to the compositions described herein being formed into a particular shape. As an example, articles may be formed from the dynamic cross-linked polymer compositions of the present disclosure and may include composites, a thermoformed material, or a combination thereof. The articles may further comprise a solder bonded to the formed article. It is understood that such examples are not intended to be limiting, but are illustrative in nature. It is understood that the subject compositions may be used for various articles and end-use applications.

With thermosetting resins of the prior art, once the resin has hardened (i.e. reached or exceeded the gel point), the article can no longer be transformed or repaired or recycled. Applying a moderate temperature to such an article does not lead to any observable or measurable transformation, and the application of a very high temperature leads to degradation of this article. In contrast, articles formed from the dynamic cross-linked polymer compositions described herein, on account of their particular composition, can be transformed, repaired, or recycled by raising the temperature of the article.

From a practical point of view, this means that over a broad temperature range, the article can be deformed, with internal constraints being removed at higher temperatures. Without being bound by theory, it is believed that transesterification exchanges in the dynamic cross-linked polymer compositions are the cause of the relaxation of constraints and of the variation in viscosity at high temperatures. In terms of application, these materials can be treated at high temperatures, where a low viscosity allows injection or molding in a press. It should be noted that, contrary to Diels-Alder reactions, no de-polymerization is observed at high temperatures and the material conserves its crosslinked structure. This property allows the repair of two parts of an article. No mold is necessary to maintain the shape of the components during the repair process at high temperatures. Similarly, components can be transformed by application of a mechanical force to only one part of an article without the need for a mold, since the material does not flow.

Raising the temperature of the article can be performed by any known means such as heating by conduction, convection, induction, spot heating, infrared, microwave or radiant heating. Devices for increasing the temperature of the article in order to perform the processes of described herein can include: an oven, a microwave oven, a heating resistance, a flame, an exothermic chemical reaction, a laser beam, a hot iron, a hot-air gun, an ultrasonication tank, a heating punch, etc. The temperature increase can be performed in discrete stages, with their duration adapted to the expected result.

Although the dynamic cross-linked polymer compositions do not flow during the transformation, by means of the transesterification reactions, by selecting an appropriate temperature, heating time and cooling conditions, the new shape may be free of any residual internal constraints. The newly shaped dynamic cross-linked polymer compositions are thus not embrittled or fractured by the application of the mechanical force. Furthermore, the article will not return to its original shape. Specifically, the transesterification reactions that take place at high temperature promote a reorganization of the crosslinking points of the polymer network so as to remove any stresses caused by application of the mechanical force. A sufficient heating time makes it possible to completely cancel these stresses internal to the material that have been caused by the application of the external mechanical force. This makes it possible to obtain stable complex shapes, which are difficult or even impossible to obtain by molding, by starting with simpler elemental shapes and applying mechanical force to obtain the desired more complex final shape. Notably, it is very difficult to obtain by molding shapes resulting from twisting. An article made from a dynamic cross-linked polymer composition can be heated and deformed, and upon returning to the original temperature, maintains the deformed shape. As such, articles in accordance with the present disclosure may comprise a shape generated by applying mechanical forces to a molded piece formed from the dynamic cross-linked polymer composition.

According to one variant, a process for obtaining and/or repairing an article based on a dynamic cross-linked polymer composition described herein comprises: placing in contact with each other two articles formed from a dynamic cross-linked polymer composition; and heating the two articles so as to obtain a single article. The heating temperature (T) is generally within the range from 50° C. to 250° C., including from 100° C. to 200° C. An article made of dynamic cross-linked polymer compositions as described herein may also be recycled by direct treatment of the article, for example, the broken or damaged article is repaired by means of a transformation process as described above and may thus regain its prior working function or another function. Alternatively, the article is reduced to particles by application of mechanical grinding, and the particles thus obtained may then be used to manufacture a new article.

The following examples are provided to illustrate the compositions, processes, and properties of the present disclosure. The examples are merely illustrative and are not intended to limit the disclosure to the materials, conditions, or process parameters set forth therein.

The present disclosure relates to at least the following aspects.

Aspect 1A. A continuous process for formation of a dynamically cross-linked polymer composition, comprising: contacting 1,4-butane diol (BDO) and purified terephthalic acid (PTA) so as to form a mixture, wherein a molar ratio of BDO to PTA is about from 2:1 to about 4:1; in a continuous fashion, catalytically esterifying the mixture, catalytically transesterifying the mixture, or both, so as to give rise to a first product and, optionally, supplying an additional amount of BDO to the first product; subjecting a product of step (b) to a first stage at a first pressure and a first temperature and then a second stage at a second pressure and a second temperature, wherein the second pressure is less than the first pressure and wherein the second temperature is greater than the first temperature; effecting, in a continuous fashion, an increase in intrinsic viscosity of a product of step (c), a decrease in carboxylic end group concentration of a product of step (c), or both; and supplying in a continuous fashion a product of step (d), a chain extender, and optionally a metal compounded catalyst to at least one of a reactive extruder or a reactor and effecting a polycondensation reaction therein so as to give rise to a product, wherein the product of step (d) and the chain extender and optional catalyst are subjected to a temperature of about 230° C. to about 255° C. and a pressure of 0.1 mbar to 16 mbar at a residence time of from about 20 seconds to 6 about hours.

Aspect 1B. A continuous process for formation of a dynamically cross-linked polymer composition, consisting of: contacting 1,4-butane diol (BDO) and purified terephthalic acid (PTA) so as to form a mixture, wherein a molar ratio of BDO to PTA is about from 2:1 to about 4:1; in a continuous fashion, catalytically esterifying the mixture, catalytically transesterifying the mixture, or both, so as to give rise to a first product and, optionally, supplying an additional amount of BDO to the first product; subjecting a product of step (b) to a first stage at a first pressure and a first temperature and then a second stage at a second pressure and a second temperature, wherein the second pressure is less than the first pressure and wherein the second temperature is greater than the first temperature; effecting, in a continuous fashion, an increase in intrinsic viscosity of a product of step (c), a decrease in carboxylic end group concentration of a product of step (c), or both; and supplying in a continuous fashion a product of step (d), a chain extender, and optionally a metal compounded catalyst to at least one of a reactive extruder or a reactor and effecting a polycondensation reaction therein so as to give rise to a product, wherein the product of step (d) and the chain extender and optional catalyst are subjected to a temperature of about 230° C. to about 255° C. and a pressure of 0.1 mbar to 16 mbar at a residence time of from about 20 seconds to 6 about hours.

Aspect 1C. A continuous process for formation of a dynamically cross-linked polymer composition, consisting essentially of: contacting 1,4-butane diol (BDO) and purified terephthalic acid (PTA) so as to form a mixture, wherein a molar ratio of BDO to PTA is about from 2:1 to about 4:1; in a continuous fashion, catalytically esterifying the mixture, catalytically transesterifying the mixture, or both, so as to give rise to a first product and, optionally, supplying an additional amount of BDO to the first product; subjecting a product of step (b) to a first stage at a first pressure and a first temperature and then a second stage at a second pressure and a second temperature, wherein the second pressure is less than the first pressure and wherein the second temperature is greater than the first temperature; effecting, in a continuous fashion, an increase in intrinsic viscosity of a product of step (c), a decrease in carboxylic end group concentration of a product of step (c), or both; and supplying in a continuous fashion a product of step (d), a chain extender, and optionally a metal compounded catalyst to at least one of a reactive extruder or a reactor and effecting a polycondensation reaction therein so as to give rise to a product, wherein the product of step (d) and the chain extender and optional catalyst are subjected to a temperature of about 230° C. to about 255° C. and a pressure of 0.1 mbar to 16 mbar at a residence time of from about 20 seconds to 6 about hours.

Aspect 2. The continuous process of any of aspects 1A-1C, further comprising subjecting a product of step (e) to a curing process.

Aspect 3. The continuous process of any of aspects 1A-2, wherein a product of step (e) has an intrinsic viscosity of between about 0.55 dl/g and about 1.35 dl/g and a carboxylic acid endgroup concentration of between about 0.1 mmol/kg and about 60 mmol/kg.

Aspect 4. The continuous process of any of aspects 1A-3, further comprising continuously supplying the product obtained from step (c) to a first continuously stirred reactor at a temperature of about 225° C. to about 250° C. and a pressure of about 5 mbar to about 70 mbar at a residence time of between about 10 minutes and about 55 minutes so as to provide a first intermediate product.

Aspect 5. The continuous process of aspect 4, further comprising continuously subjecting the first intermediate product to a temperature of about 230° C. to about 260° C. and a pressure of about 0.1 mbar to about 35 mbar at a residence time between about 10 minutes and about 60 minutes so as to provide a second intermediate product having an intrinsic viscosity between about 0.1 dl/g and about 0.4 dl/g and a carboxylic acid endgroup concentration between about 0.1 mmol/kg and about 40 mmol/kg.

Aspect 6. The continuous process of any of aspects 1A-5, wherein one or more of steps (b), (c), (d), and (e) are effected in a tower reactor having a plurality of reactor zones or are effected in a plurality of continuously stirred reactors.

Aspect 7. The continuous process of any of aspects 1A-6, wherein the first product has an intrinsic viscosity of about 0.13 dl/g to about 0.35 dl/g and a carboxylic acid endgroup concentration of about 10 mmol/kg to about 180 mmol/kg.

Aspect 8. The continuous process of any of aspects 1-7, wherein a cured product of step (e) exhibits a capability of relaxing internal residual stresses at a characteristic timescale of between about 0.1 and about 100,000 seconds above a glass transition temperature of a polymer product of claim 1, as measured by stress relaxation rheology measurement.

Aspect 9A. A continuous process for preparing polybutylene terephthalate, comprising: contacting 1,4-butane diol (BDO) and purified terephthalic acid (PTA) so as to form a mixture, wherein a molar ratio of BDO to PTA is from about 2:1 to about 4:1; in a continuous fashion, catalytically esterifying the mixture, catalytically transesterifying the mixture, or both, so as to give rise to a first product; maintaining the first product at from about 225° C. to about 280° C. and a pressure in a range of from about 1 bar to about 10 bar and supplying an additional amount of BDO so as to give rise to a second product; subjecting the second product to a first stage at a first pressure and a first temperature, then a second stage at a second pressure and a second temperature, then a third stage at a third pressure and a third temperature, then a fourth stage at a fourth pressure and a fourth temperature, wherein the pressure of a stage is lesser than the pressure of a preceding stage and wherein a temperature of a stage is greater than a temperature of the preceding stage; and supplying in a continuous fashion a product of step (b), a chain extender, and optionally a metal compounded catalyst to at least one of a reactive extruder or a reactor and effecting a polycondensation reaction therein, wherein the product of step (b) and the chain extender and optional catalyst are subjected to a temperature of about 230 to about 255° C. and a pressure of about 0.1 to about 16 mbar at a residence time of from about 20 seconds to about 6 hours.

Aspect 9B. A continuous process for preparing polybutylene terephthalate, consisting of: contacting 1,4-butane diol (BDO) and purified terephthalic acid (PTA) so as to form a mixture, wherein a molar ratio of BDO to PTA is from about 2:1 to about 4:1; in a continuous fashion, catalytically esterifying the mixture, catalytically transesterifying the mixture, or both, so as to give rise to a first product; maintaining the first product at from about 225° C. to about 280° C. and a pressure in a range of from about 1 bar to about 10 bar and supplying an additional amount of BDO so as to give rise to a second product; subjecting the second product to a first stage at a first pressure and a first temperature, then a second stage at a second pressure and a second temperature, then a third stage at a third pressure and a third temperature, then a fourth stage at a fourth pressure and a fourth temperature, wherein the pressure of a stage is lesser than the pressure of a preceding stage and wherein a temperature of a stage is greater than a temperature of the preceding stage; and supplying in a continuous fashion a product of step (b), a chain extender, and optionally a metal compounded catalyst to at least one of a reactive extruder or a reactor and effecting a polycondensation reaction therein, wherein the product of step (b) and the chain extender and optional catalyst are subjected to a temperature of about 230 to about 255° C. and a pressure of about 0.1 to about 16 mbar at a residence time of from about 20 seconds to about 6 hours.

Aspect 9C. A continuous process for preparing polybutylene terephthalate, consisting essentially of: contacting 1,4-butane diol (BDO) and purified terephthalic acid (PTA) so as to form a mixture, wherein a molar ratio of BDO to PTA is from about 2:1 to about 4:1; in a continuous fashion, catalytically esterifying the mixture, catalytically transesterifying the mixture, or both, so as to give rise to a first product; maintaining the first product at from about 225° C. to about 280° C. and a pressure in a range of from about 1 bar to about 10 bar and supplying an additional amount of BDO so as to give rise to a second product; subjecting the second product to a first stage at a first pressure and a first temperature, then a second stage at a second pressure and a second temperature, then a third stage at a third pressure and a third temperature, then a fourth stage at a fourth pressure and a fourth temperature, wherein the pressure of a stage is lesser than the pressure of a preceding stage and wherein a temperature of a stage is greater than a temperature of the preceding stage; and supplying in a continuous fashion a product of step (b), a chain extender, and optionally a metal compounded catalyst to at least one of a reactive extruder or a reactor and effecting a polycondensation reaction therein, wherein the product of step (b) and the chain extender and optional catalyst are subjected to a temperature of about 230 to about 255° C. and a pressure of about 0.1 to about 16 mbar at a residence time of from about 20 seconds to about 6 hours.

Aspect 10. The continuous process of any of aspects 9A-9C, wherein a product of step (b.iii.) has an intrinsic viscosity between about 0.08 dl/g and about 0.2 dl/g and a carboxylic acid endgroup concentration between about 10 mmol/kg and about 300 mmol/kg.

Aspect 11. The continuous process of any of aspects 9A-10, further comprising continuously supplying a product obtained from step (b.iii) to a first continuously stirred reactor at a temperature of about 225° C. to about 250° C. and a pressure of about 5 mbar to about 70 mbar at a residence time of between about 10 minutes and about 55 minutes so as to provide a first intermediate product.

Aspect 12. The continuous process of aspect 11, further comprising continuously subjecting the first intermediate product to a temperature of about 230° C. to about 260° C. and a pressure of about 0.1 mbar to about 35 mbar at a residence time between about 10 and about 60 minutes so as to provide a second intermediate product having an intrinsic viscosity between about 0.2 dl/g and about 0.4 dl/g and a carboxylic acid endgroup concentration between about 0.1 mmol/kg and about 40 mmol/kg.

Aspect 13. The continuous process of any of aspects 9A-12, wherein a product of step (c) has an intrinsic viscosity of between about 0.55 dl/g and about 1.35 dl/g and a carboxylic acid endgroup concentration of between about 0.1 mmol/kg and about 60 mmol/kg.

Aspect 14. The continuous process of any of aspects 9A-13, further comprising subjecting a product of step (c) to a curing process.

Aspect 15. The continuous process of aspect 14, wherein the curing process comprises heating a product of step (c) for at least about 30 minutes at a temperature of about 250° C.

Aspect 16. The continuous process of any of aspects 9A-14, wherein a product of step (c) exhibits a capability of relaxing internal residual stresses at a characteristic timescale of between about 0.1 and about 100,000 seconds above a glass transition temperature of a product of claim 9, as measured by stress relaxation rheology measurement.

Aspect 17A. A dynamically cross-linked network composition, comprising: a composition comprising a reaction product of polybutylene terephthalate and an amount of butanediol, the composition exhibiting a capability of relaxing internal residual stresses at a characteristic timescale of between about 0.1 and about 100,000 seconds above a glass transition temperature of the polybutylene terephthalate, as measured by stress relaxation rheology measurement.

Aspect 17B. A dynamically cross-linked network composition, consisting of: a composition comprising a reaction product of polybutylene terephthalate and an amount of butanediol, the composition exhibiting a capability of relaxing internal residual stresses at a characteristic timescale of between about 0.1 and about 100,000 seconds above a glass transition temperature of the polybutylene terephthalate, as measured by stress relaxation rheology measurement.

Aspect 17C. A dynamically cross-linked network composition, consisting essentially of: a composition comprising a reaction product of polybutylene terephthalate and an amount of butanediol, the composition exhibiting a capability of relaxing internal residual stresses at a characteristic timescale of between about 0.1 and about 100,000 seconds above a glass transition temperature of the polybutylene terephthalate, as measured by stress relaxation rheology measurement.

Aspect 18. The dynamically cross-linked network composition of any of aspects 17A-17C, wherein a molar ratio of butanediol to polybutylene terephthalate is from about 2:1 to about 4:1.

Aspect 19. The dynamically cross-linked network composition of any of aspects 17A-17C, wherein a molar ratio of butanediol to polybutylene terephthalate is about 3:1.

Aspect 20. The dynamically cross-linked network composition of any of aspects 17A-19, further comprising one or more additives.

### Examples

Materials: Pyromellitic Dianhydride chain extender (PMDA) (Acros Chemicals); Zinc(II)acetate (H₂O) (Acros Chemicals); Titanium(IV) isopropoxide (tetraisopropyl titanate, TPT) (Commercial Tyzor grade, Dorf Ketal); Purified Terephthalic Acid (PTA, purity greater than 99%) (CEPSA Chemicals); and Butanediol (BDO) (BASF).

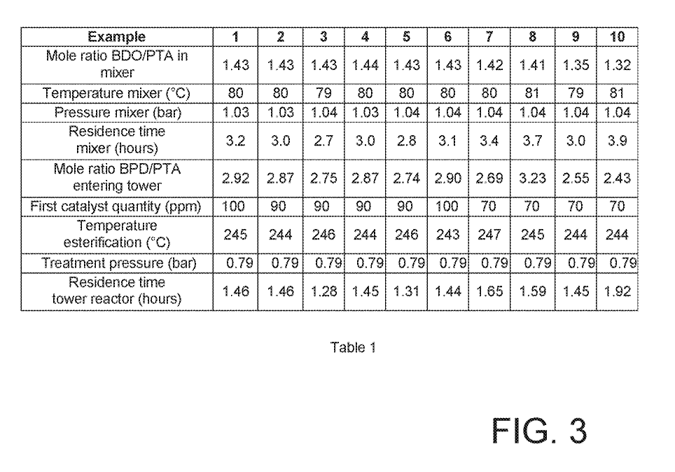

Experiments 1-10 were performed in a continuously operating process according to the conditions set out here below. BDO and PTA were mixed in a mole ratio as presented in Table 1 in a slurry paste vessel to form a mixture. Table 1 presented in FIG. 3 provides the temperature, pressure and residence time in the slurry paste vessel as well as the esterification portion of the tower reactor.

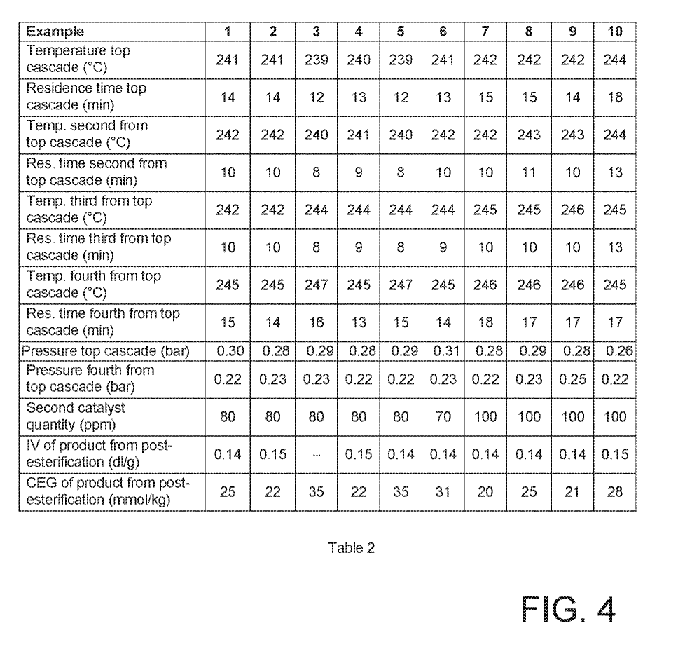

The slurry paste from the mixer was mixed with additional BDO such that the BDO:PTA ratio was as listed in Table 2 as presented in FIG. 4 before being transferred to a tower reactor where an esterification process occurred in the lower section of the reactor. A first quantity of TPT catalyst as shown in Table 2 was supplied in the esterification section. Treatment temperatures, pressure and residence time in the esterification section are listed in Table 2.

The product from the esterification section was transferred continuously to the cascade post-esterification portion of the tower reactor which consisted of four different cascades. The temperature and residence time in each cascade are listed in Table 2. The pressure in the top cascade and the pressure in the fourth-from-top cascade are listed in Table 2. The pressure of the post-esterification section was gradually decreased from the top cascade to the bottom cascade. In the fourth from top cascade, a second quantity of TPT catalyst diluted with 0.2 mole of BDO as listed in Table 2 was supplied. The IV and CEG of the product at the end of the post-esterification section are listed in table 2.

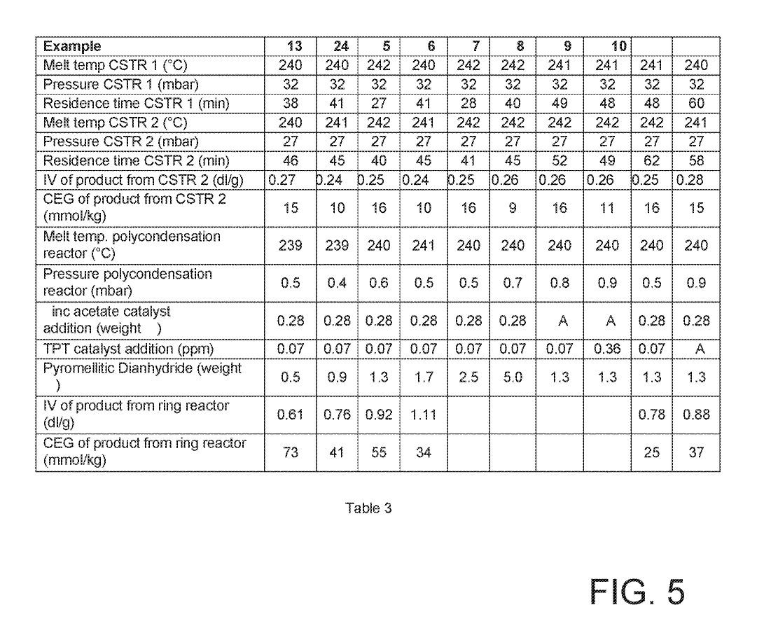

The product from the post-esterification section was continuously supplied to the first continuously stirred tank reactor (CSTR 1). The melt temperature, pressure and residence time in CSTR 1 are listed in Table 3 presented in FIG. 5. The product from CSTR 1 was continuously supplied to a second continuously stirred tank reactor (CSTR 2). The melt temperature, pressure and residence time in CSTR 2 are listed in Table 3. The IV and CEG of the product leaving CSTR 2 are listed in Table 3. The product from CSTR 2 was continuously transferred to a polycondensation reactor. The melt temperature and pressure are listed in Table 3 as well as the additions of the chain extender, zinc acetate catalyst, and titanium catalyst. The IV and CEG of the resulting products are listed in table 3. XL indicates a cross-link network has formed.

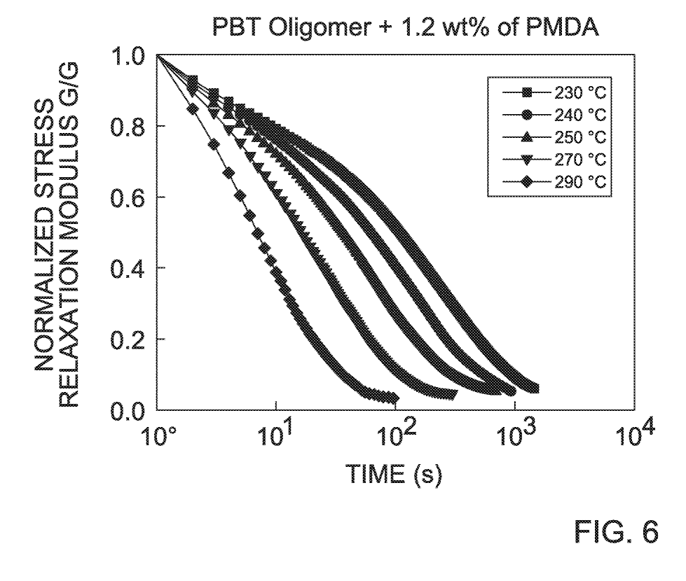

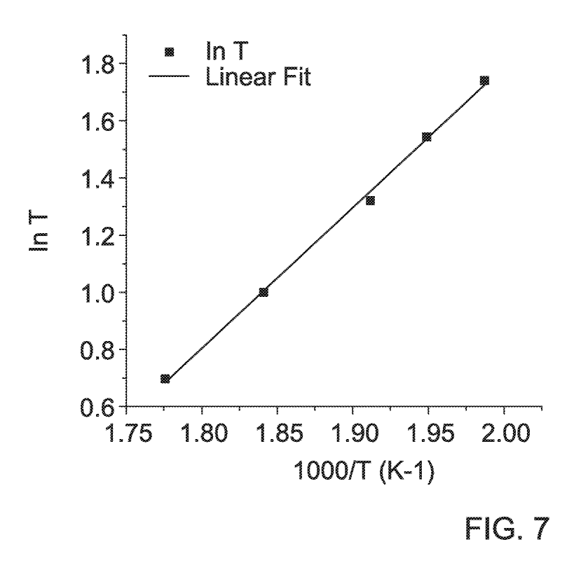

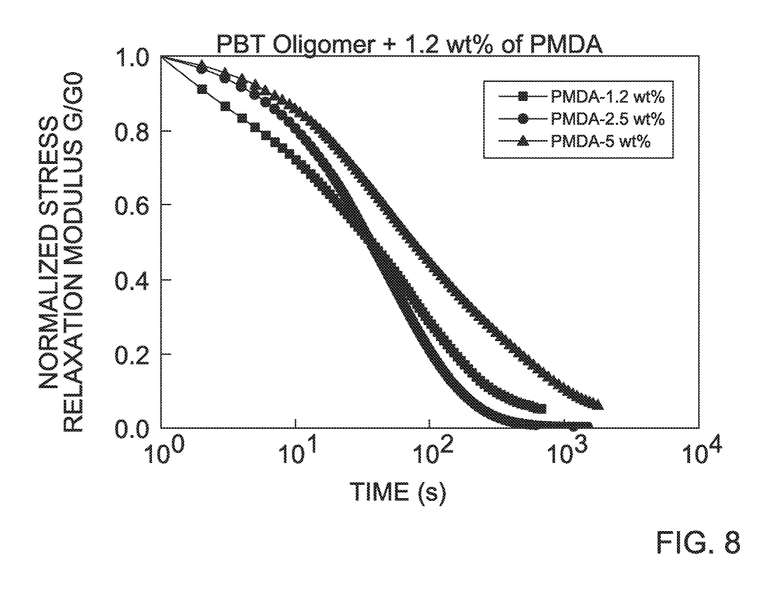

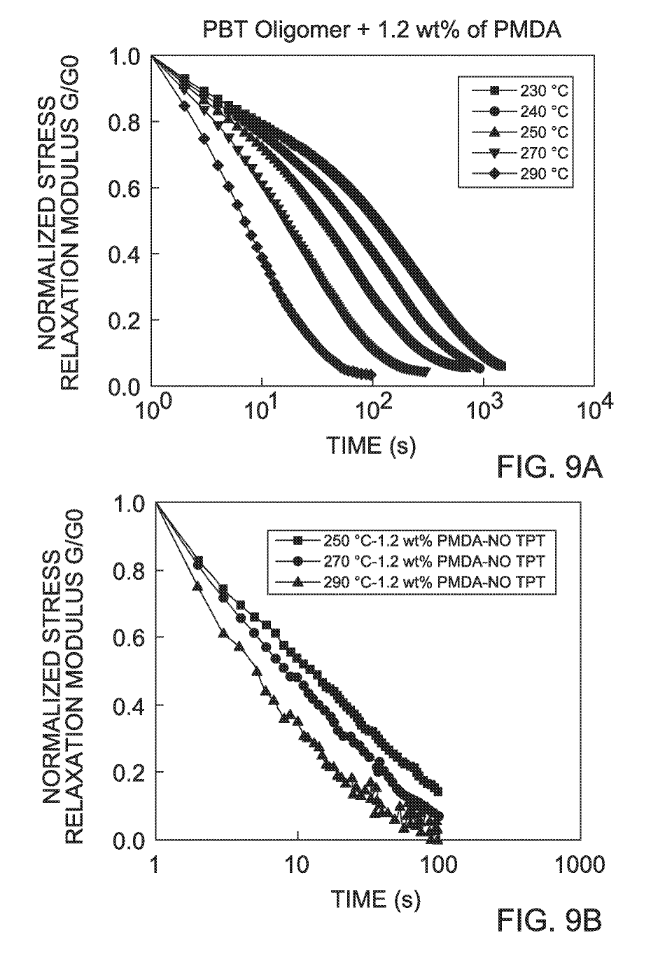

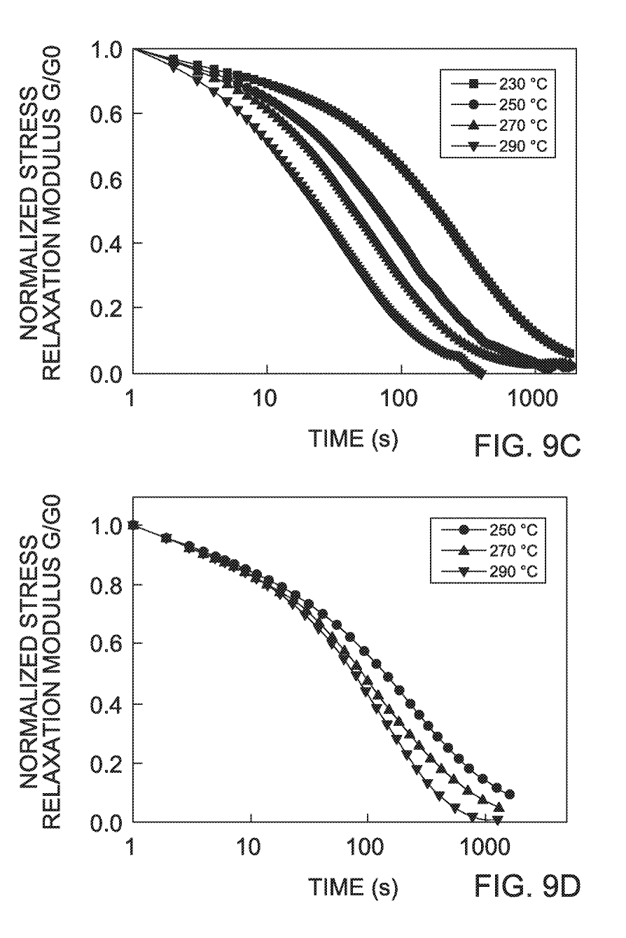

Stress relaxation analyses were performed on selected samples in the linear viscoelastic regime. Typically, a thermoplastic relaxes fast in a short period of time, while a classic thermoset does not show obvious relaxation below degradation temperature. A DCN, is expected to exhibit the behavior of a thermoset at lower temperatures, but at higher temperatures it is expected to exhibit relaxation. The relaxation time may be dependent on temperature such that the higher the temperature, the shorter time relaxation time. As expected, samples from the mixing experiments (slurry paste mixture) exhibited no DCN property, but showed the behavior of oligomers. The samples obtained after the polycondensation reactor and prepared under vacuum, however, showed promising DCN behaviors. In FIG. 6, stress relaxation results are shown for Example 3 at various temperatures between 230 to 290° C. All the experiments were performed after a post curing step of minimum 30 minutes at 250° C. At lower temperature, stress relaxes slower, while at elevated temperature network rearrangement becomes more active and so stress relaxes faster, proving the dynamic nature of the network. Further, an Arrhenius plot of the log of the values of characteristic relaxation time (τ*) versus 1000/T shows linear relation (FIG. 7). FIG. 8 presents the stress relaxation properties of Examples 3, 5, and 6 at different loadings of PMDA at 250° C. FIGS. 9A-9D presents the stress relaxation properties of Examples 7-10 for comparison. Without the addition of TPT (Example 10) in FIG. 9B, fast relaxation was observed which corresponded to more thermoplastic behavior of the product. In FIG. 9C, presenting the stress relaxation of Example 7, characteristic dynamically cross-linked behavior was observed. The stress relaxed slower than in Example 9 (FIG. 9A). However, when 5-fold TPT was used as in Example 8 (FIG. 9D) the afforded network behaved more like a thermoset in stress relaxation tests, in which the relaxation time did not change much as the temperature was increased from 250° C. to 290° C. This may be attributed to the occurrence that under higher TPT concentration, most of the hydroxyl groups were consumed to form esters. Thus, there were not enough free hydroxyl groups for the transesterification reaction to occur. While these results further confirmed that the zinc catalyst can accelerate the dynamic transesterification process in the network, it also revealed that a certain amount of TPT alone may also catalyze the transesterification reaction.

It will be apparent to those skilled in the art that various modifications and variations can be made in the present disclosure without departing from the scope or spirit of the disclosure. Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A continuous process for formation of a dynamically cross-linked polymer composition, comprising:
a) contacting 1,4-butane diol (BDO) and purified terephthalic acid (PTA) so as to form a mixture, wherein a molar ratio of BDO to PTA is about from 2:1 to about 4:1;
b) in a continuous fashion, catalytically esterifying the mixture, catalytically transesterifying the mixture, or both, so as to give rise to a first product and, optionally, supplying an additional amount of BDO to the first product;
c) subjecting a product of step (b) to a first stage at a first pressure and a first temperature and then a second stage at a second pressure and a second temperature, wherein the second pressure is less than the first pressure and wherein the second temperature is greater than the first temperature;
d) effecting, in a continuous fashion, an increase in intrinsic viscosity of a product of step (c), a decrease in carboxylic end group concentration of a product of step (c), or both; and
e) supplying in a continuous fashion a product of step (d), a chain extender, and optionally a metal compounded catalyst to at least one of a reactive extruder or a reactor and effecting a polycondensation reaction therein so as to give rise to a product, wherein the product of step (d) and the chain extender and optional catalyst are subjected to a temperature of about 230° C. to about 255° C. and a pressure of 0.1 mbar to 16 mbar at a residence time of from about 20 seconds to 6 about hours.

2. The continuous process of claim 1, further comprising subjecting a product of step (e) to a curing process.

3. The continuous process of claim 1, wherein a product of step (e) has an intrinsic viscosity of between about 0.55 dl/g and about 1.35 dug and a carboxylic acid endgroup concentration of between about 0.1 mmol/kg and about 60 mmol/kg.

4. The continuous process of claim 1, further comprising continuously supplying the product obtained from step (c) to a first continuously stirred reactor at a temperature of about 225° C. to about 250° C. and a pressure of about 5 mbar to about 70 mbar at a residence time of between about 10 minutes and about 55 minutes so as to provide a first intermediate product.

5. The continuous process of claim 4, further comprising continuously subjecting the first intermediate product to a temperature of about 230° C. to about 260° C. and a pressure of about 0.1 mbar to about 35 mbar at a residence time between about 10 minutes and about 60 minutes so as to provide a second intermediate product having an intrinsic viscosity between about 0.1 dl/g and about 0.4 dl/g and a carboxylic acid endgroup concentration between about 0.1 mmol/kg and about 40 mmol/kg.

6. The continuous process of claim 1, wherein one or more of steps (b), (c), (d), and (e) are effected in a tower reactor having a plurality of reactor zones or are effected in a plurality of continuously stirred reactors.

7. The continuous process of claim 1, wherein the first product has an intrinsic viscosity of about 0.13 dl/g to about 0.35 dl/g and a carboxylic acid endgroup concentration of about 10 mmol/kg to about 180 mmol/kg.

8. The continuous process of claim 1, wherein a cured product of step (e) exhibits a capability of relaxing internal residual stresses at a characteristic timescale of between about 0.1 and about 100,000 seconds above a glass transition temperature of a polymer product of claim 1, as measured by stress relaxation rheology measurement.

9. A continuous process for preparing polybutylene terephthalate, comprising:
a. contacting 1,4-butane diol (BDO) and purified terephthalic acid (PTA) so as to form a mixture, wherein a molar ratio of BDO to PTA is from about 2:1 to about 4:1;
b. in a continuous fashion,
i. catalytically esterifying the mixture, catalytically transesterifying the mixture, or both, so as to give rise to a first product;
ii. maintaining the first product at from about 225° C. to about 280° C. and a pressure in a range of from about 1 bar to about 10 bar and supplying an additional amount of BDO so as to give rise to a second product;
iii. subjecting the second product to a first stage at a first pressure and a first temperature, then a second stage at a second pressure and a second temperature, then a third stage at a third pressure and a third temperature, then a fourth stage at a fourth pressure and a fourth temperature, wherein the pressure of a stage is lesser than the pressure of a preceding stage and wherein a temperature of a stage is greater than a temperature of the preceding stage; and
c. supplying in a continuous fashion a product of step (b), a chain extender, and optionally a metal compounded catalyst to at least one of a reactive extruder or a reactor and effecting a polycondensation reaction therein, wherein the product of step (b) and the chain extender and optional catalyst are subjected to a temperature of about 230 to about 255° C. and a pressure of about 0.1 to about 16 mbar at a residence time of from about 20 seconds to about 6 hours.

10. The continuous process of claim 9, wherein a product of step (b.iii.) has an intrinsic viscosity between about 0.08 dl/g and about 0.2 dl/g and a carboxylic acid endgroup concentration between about 10 mmol/kg and about 300 mmol/kg.

11. The continuous process of claim 9, further comprising continuously supplying a product obtained from step (b.iii) to a first continuously stirred reactor at a temperature of about 225° C. to about 250° C. and a pressure of about 5 mbar to about 70 mbar at a residence time of between about 10 minutes and about 55 minutes so as to provide a first intermediate product.

12. The continuous process of claim 11, further comprising continuously subjecting the first intermediate product to a temperature of about 230° C. to about 260° C. and a pressure of about 0.1 mbar to about 35 mbar at a residence time between about 10 and about 60 minutes so as to provide a second intermediate product having an intrinsic viscosity between about 0.2 dl/g and about 0.4 dl/g and a carboxylic acid endgroup concentration between about 0.1 mmol/kg and about 40 mmol/kg.

13. The continuous process of claim 9, wherein a product of step (c) has an intrinsic viscosity of between about 0.55 dl/g and about 1.35 dl/g and a carboxylic acid endgroup concentration of between about 0.1 mmol/kg and about 60 mmol/kg.

14. The continuous process of claim 9, further comprising subjecting a product of step (c) to a curing process.

15. The continuous process of claim 14, wherein the curing process comprises heating a product of step (c) for at least about 30 minutes at a temperature of about 250° C.

16. The continuous process of claim 9, wherein a product of step (c) exhibits a capability of relaxing internal residual stresses at a characteristic timescale of between about 0.1 and about 100,000 seconds above a glass transition temperature of a product of claim 9, as measured by stress relaxation rheology measurement.

17. A dynamically cross-linked network composition, comprising:
a composition comprising a reaction product of polybutylene terephthalate and an amount of butanediol,
the composition exhibiting a capability of relaxing internal residual stresses at a characteristic timescale of between about 0.1 and about 100,000 seconds above a glass transition temperature of the polybutylene terephthalate, as measured by stress relaxation rheology measurement.

18. The dynamically cross-linked network composition of claim 17, wherein a molar ratio of butanediol to polybutylene terephthalate is from about 2:1 to about 4:1.

19. The dynamically cross-linked network composition of claim 17, wherein a molar ratio of butanediol to polybutylene terephthalate is about 3:1.

20. The dynamically cross-linked network composition of claim 17, further comprising one or more additives.
